(19) United States
(12) Patent Application Publication
(10) Pub. No.: US 2023/0345249 A1
(43) Pub. Date: Oct. 26, 2023

(54) Misbehavior Indication Aggregators For Identifying Misbehavior Conditions In Vehicle-To-Everything (V2X) Communication Systems

(71) Applicant: QUALCOMM Incorporated, San Diego, CA (US)

(72) Inventors: Mohammad Raashid ANSARI, Lowell, MA (US); Jonathan PETIT, Wenham, MA (US); Jean-Philippe MONTEUUIS, Shrewsbury, MA (US); Cong CHEN, Shrewsbury, MA (US)

(21) Appl. No.: 17/660,513

(22) Filed: Apr. 25, 2022

(51) Int. Cl. H04W 12/122; H04W 4/40

(52) U.S. Cl. CPC H04W 12/122; H04W 4/40

(57) ABSTRACT

Embodiment methods implemented in vehicle-to-everything (V2X) systems may include detecting multiple indications of V2X misbehavior by multiple misbehavior detection mechanisms, aggregating misbehavior indications output from the misbehavior detection mechanisms, determining whether a reportable or actionable misbehavior condition exists based on aggregated misbehavior indications, and acting on a determined misbehavior condition. Aggregating misbehavior indications may include determining whether any of the misbehavior detection mechanisms outputs a misbehavior indication, determining whether any one of a select subset of the one or more misbehavior detection mechanisms outputs a misbehavior indication, aggregating misbehavior indications output from multiple misbehavior detection mechanisms and comparing the number to a threshold, applying a weight to misbehavior indication outputs and aggregating the weighted outputs, or determining a number of events classified as an attack or misbehavior indications output by each of a plurality of misbehavior detection mechanisms within a window of time or set number of events.

### BACKGROUND

Vehicle-to-Everything (V2X) systems may employ protocols and messaging defined under a relevant standard, such as Cellular Vehicle-to-Everything (C-V2X), Dedicated Short Range Communication (DSRC), and ITS-G5. These standards serve as the foundation for vehicle-based wireless communications, and may be used to support intelligent highways, autonomous and semi-autonomous vehicles, and improve the overall efficiency and safety of the highway transportation systems. An element of V2X systems is the ability for a vehicle to broadcast V2X messages that other vehicles can receive and process to improve traffic safety, such as Basic Safety Messages (BSM) or Cooperative Awareness Messages (CAM).

V2X systems may be configured to detect inaccurate or intentionally false information in a V2X message received from another vehicle or from Intelligent Transportation System (ITS) infrastructure devices, such as Roadside Units (RSUs). Further, V2X systems may be configured to send a report of detected inaccurate or intentionally false information to a Misbehavior Authority (Misbehavior Authority) computing device. However, if numerous V2X systems detect and send a report about such inaccurate or intentionally false information, a Misbehavior Authority computing device may receive numerous redundant reports, potentially overloading the Misbehavior Authority computing device. Further, the sending of redundant reports consumes finite communication network resources and processing capacity of the V2X systems and the Misbehavior Authority computing device.

### SUMMARY

Various aspects include methods performed by a processor of a vehicle-to-everything (V2X) communication system of a vehicle for aggregating indications of misbehavior before determining that a misbehavior condition exists. Various aspects may include detecting multiple indications of V2X misbehavior via one or more misbehavior detection mechanisms, aggregating misbehavior indications output from the one or more misbehavior detection mechanisms, determining whether a reportable or actionable misbehavior condition exists based on aggregated misbehavior indications, and transmitting a misbehavior report or taking a responsive action in response to determining that a misbehavior condition exists.

In some aspects, aggregating misbehavior indications output from the one or more misbehavior detection mechanisms may include determining whether any of the one or more misbehavior detection mechanisms outputs a misbehavior indication, and determining whether a reportable or actionable misbehavior condition exists based on aggregated misbehavior indications may include determining that a reportable or actionable misbehavior condition exists in response to determining that at least one of the misbehavior detection mechanisms outputs a misbehavior indication.

In some aspects, aggregating misbehavior indications output from the one or more misbehavior detection mechanisms may include determining whether any one of a select subset of the one or more misbehavior detection mechanisms outputs a misbehavior indication, and determining whether a reportable or actionable misbehavior condition exists based on aggregated misbehavior indications may include determining that a reportable or actionable misbehavior condition exists in response to determining that at least one of the select subset of misbehavior detection mechanisms outputs a misbehavior indication.

In some aspects, aggregating misbehavior indications output from the one or more misbehavior detection mechanisms may include aggregating misbehavior indications output from multiple misbehavior detection mechanisms, and determining whether a reportable or actionable misbehavior condition exists based on aggregated misbehavior indications may include determining that a reportable or actionable misbehavior condition exists in response to a threshold number of the misbehavior detection mechanisms outputting misbehavior indications.

The method of claim 4, in which determining that a reportable or actionable misbehavior condition exists in response to a threshold number of the misbehavior detection mechanisms outputting misbehavior indications may include determining that a reportable or actionable misbehavior condition exists in response to a majority of the misbehavior detection mechanisms outputting misbehavior indications.

In some aspects, aggregating misbehavior indications output from the one or more misbehavior detection mechanisms may include: applying a respective weight to outputs of each of the one or more misbehavior detection mechanisms, and aggregating the weighted outputs of the one or more misbehavior detection mechanisms, and determining whether a reportable or actionable misbehavior condition exists based on aggregated misbehavior indications may include determining that a reportable or actionable misbehavior condition exists in response to the weighted outputs of misbehavior detection mechanisms exceeding a threshold.

In some aspects, detecting multiple indications of V2X misbehavior via one or more misbehavior detection mechanism may include processing received V2X information through a plurality of plausibility and consistency detectors configured to detect misbehavior conditions and output misbehavior indications to a detector selector, aggregating misbehavior indications output from the one or more misbehavior detection mechanisms may include passing outputs of misbehavior indications from a selected subset of the plurality of plausibility and consistency detectors from the detector selector to a misbehavior detector, determining whether a reportable or actionable misbehavior condition exists based on aggregated misbehavior indications may include determining by the misbehavior detector that a reportable or actionable misbehavior condition exists in response to misbehavior indication outputs by the selected subset of the plurality of plausibility and consistency detectors, and the method further may include: determining a rate of misbehavior determinations, determining whether the rate of misbehavior determinations exceeds a maximum threshold or is less than a minimum threshold, deactivating one or more sensitive plausibility and consistency detectors in response to determining that the rate of misbehavior determinations exceeds the maximum threshold, and activating one or more sensitive plausibility and consistency detectors in response to determining that the rate of misbehavior determinations is less than the minimum threshold.

In some aspects, aggregating misbehavior indications output from the one or more misbehavior detection mechanisms may include determining a number of events classified as an attack or misbehavior indications output by each of a plurality of misbehavior detection mechanisms within a window of time or set number of events, and determining whether a reportable or actionable misbehavior condition exists based on aggregated misbehavior indications may include determining that a reportable or actionable misbehavior condition exists in response to determining that the number of events classified as an attack or misbehavior indications output by any one of the plurality of misbehavior detection mechanisms within the window of time or set number of events exceeds a threshold.

Further aspects include a V2X communications processing and management system including a memory and a processor configured to perform operations of any of the methods summarized above. Further aspects may include a V2X communications processing and management system having various means for performing functions corresponding to any of the methods summarized above. Further aspects may include a non-transitory processor-readable storage medium having stored thereon processor-executable instructions configured to cause a processor of a V2X communications processing and management system to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example V2X communication system suitable for implementing various embodiments.

FIG. 1B is a system block diagram illustrating an example disaggregated base station architecture for wireless communication systems suitable for implementing any of the various embodiments.

FIG. 2A is a component diagram of an example V2X communications processing and management system suitable for implementing various embodiments.

FIG. 2B is a component block diagram illustrating computational layers of an example vehicle V2X communications processing and management system according to various embodiments.

FIG. 3 is a block diagram illustrating components of a system on chip for use in a vehicle V2X communications processing and management system in accordance with various embodiments.

FIG. 4A is a notional block diagram illustrating functional elements of a V2X misbehavior detection system including a plurality of aggregators of implausible and inconsistency detections for making misbehavior determinations in accordance with various embodiments.

FIG. 4B is a notional block diagram illustrating functional elements of an aggregator method or module according to a first embodiment.

FIG. 4C is a notional block diagram illustrating functional elements of an aggregator method or module according to a second embodiment suitable for use in the V2X misbehavior detection system illustrated in FIG. 4A.

FIG. 4D is a notional block diagram illustrating functional elements of an aggregator method or module according to a third embodiment suitable for use in the V2X misbehavior detection system illustrated in FIG. 4A.

FIG. 4E is a notional block diagram illustrating functional elements of an aggregator method or module according to a fourth embodiment suitable for use in the V2X misbehavior detection system illustrated in FIG. 4A.

FIG. 4F is a notional block diagram illustrating functional elements of an aggregator method or module according to a fifth embodiment suitable for use in the V2X misbehavior detection system illustrated in FIG. 4A.

FIG. 4G is a notional block diagram illustrating functional elements of an aggregator method or module according to a sixth embodiment suitable for use in the V2X misbehavior detection system illustrated in FIG. 4A.

FIG. 5A is a process flow diagram of an example method 500a for detecting and acting on a V2X misbehavior condition in accordance with various embodiments.

FIGS. 5B-5G are process flow diagrams of example operations 500b-500g that may be performed as part of the method 500a for aggregating implausible and inconsistency detections for making misbehavior determinations in accordance with some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and processors of a vehicle V2X communications processing and management system that implements one or more aggregators of misbehavior indications identified by any of a number of multiple implausible and inconsistency detection mechanisms, algorithms, modules and/or detectors configure to recognize evidence of events involving inconsistent or implausible information within or received from V2X messages, vehicles sensors, network information, and the like. Various embodiments include OR gate aggregators, quorum-based aggregators, majority-based aggregators, misbehavior-in-majority V2X information aggregators, adaptive aggregators, and combinations two or more of such aggregators. Aggregating misbehavior indications generated by multiple implausible and inconsistency detection mechanisms may improve the identification of actual misbehavior conditions, avoid or reduce false alarms, and/or reduce the generation of redundant misbehavior reports and/or responses to misbehavior reports. Various embodiments include different methods for aggregating misbehavior conditions and determining when a reportable or actionable misbehavior condition exits.

As used herein, the term “vehicle” refers generally to any of an automobile, truck, bus, train, boat, and any other type of mobile ADS-capable system that may access map data to perform autonomous or semi-autonomous functions.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Standards are being developed in multiple regions of the world for vehicle-based communication systems and functionality. Examples include standards being developed by the Institute of Electrical and Electronics Engineers (IEEE) and Society of Automotive Engineers (SAE) for use in North America, or in the European Telecommunications Standards Institute (ETSI) and European Committee for Standardization (CEN) for use in Europe. For example, the IEEE 802.11p standard is the basis for the Dedicated Short Range Communication (DSRC) and ITS-G5 communication standards. IEEE 1609 is a higher layer standard based on IEEE 802.11p. The Cellular Vehicle-to-Everything (C-V2X) standard is a competing standard developed under the auspices of the 3rd Generation Partnership Project. These standards serve as the foundation for vehicle-based wireless communications, and may be used to support intelligent highways, autonomous and semi-autonomous vehicles, and improve the overall efficiency and safety of the highway transportation systems. ITS communications may be supported by next-generation 5G NR communication systems. These and other V2X wireless technologies may be used in various embodiments.

The C-V2X protocol defines two transmission modes that, together, provide a 360° non-line-of-sight awareness and a higher level of predictability for enhanced road safety and autonomous driving. A first transmission mode includes direct C-V2X, which includes vehicle-to-vehicle (V2V), vehicle-to-infrastructure (V2I), and vehicle-to-pedestrian (V2P), and that provides enhanced communication range and reliability in the dedicated Intelligent Transportation System (ITS) 5.9 gigahertz (GHz) spectrum that is independent of a cellular network. A second transmission mode includes vehicle-to-network communications (V2N) in mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation new radio wireless mobile communication technologies (5G NR systems, etc.), etc.

The processing of such messages in transmitting and receiving vehicles may be performed by a processor or processing system of onboard equipment that provides the vehicle-to-everything (V2X) functionality, which are referred to herein generally as a “V2X communications processing and management system” or simply as a “V2X processing system.”

V2X systems and technologies hold great promise for improving traffic flows and vehicle safety by enabling vehicles to share information regarding their location, speed, direction of travel, braking, and other factors that may be useful to other vehicles for anti-collision and other safety functions. An element of V2X systems is the ability for a vehicle to broadcast V2X information in a V2X message, such as a Basic Safety Messages (BSM) or a Cooperative Awareness Messages (CAM) in Europe, which other vehicles can receive and process to improve traffic safety. A vehicle may transmit a V2X message frequently, in some implementations up to 20 times per second. With most or all vehicles transmitting V2X information, receiving vehicles may receive information from other vehicles to control their own speed, direction, maneuvering, path planning, etc. to avoid collisions and efficiently and safely position vehicles with respect to each other. Further, V2X equipped vehicles may improve traffic flow by safely reducing separation distances, platooning several vehicles together, and avoiding vehicles experiencing breakdowns.

In V2X communications, it is important that inaccurate, corrupted, or intentionally falsified data is detected and mitigated. However, as an increasing number of ITS participants are equipped to participate in such networks, the volume of potentially inaccurate, corrupted, or intentionally falsified information (sometimes referred to herein as “misbehavior”) is large and growing at an exponential rate. For example, a misbehaving ITS participant that is a car may send a V2X message that inaccurately declares that the car has the dimensions of a bus, in order to fool other nearby ITS participants into staying further away from the car. As another example, a misbehaving ITS participant may inaccurately indicate that the width of the ITS participant occupies most of the road width, so that other vehicles do not attempt to pass the ITS participant. As another example, a misbehaving ITS participant (e.g., a scooter) may indicate that it is a pedestrian type of ITS participant in order to drive on a sidewalk without triggering a system alert or alarm, e.g., an alert sent to the police. Further, a faulty vehicle sensor or processing errors may provide inaccurate V2X information. Such misbehaviors by ITS participants, whether the result of malfunctioning equipment or an intentional attack, can reduce the efficiency of the ITS, and in some cases place human health and safety at risk.

A number of methods are known for detecting V2X messages that include (or could include) inaccurate or spurious information, as well as detecting sensor and other vehicle data indicating a misbehavior condition that could lead to generating a misbehavior report and/or requiring a safety response by the vehicle. Such methods may be implemented in a V2X processing system as misbehavior detection mechanisms, which may be implemented in software as algorithms, in software modules of the V2X processing system and/or in circuitry or dedicated processors (referred to herein generally as a “device”). Some misbehavior detection mechanisms may be configured to detect inconsistencies in the information included in the V2X message. Some misbehavior detection mechanisms may be configured to detect when information in a V2X message conflicts with information that is known to receiving V2X processors and/or V2X communication system, such as location information that differs substantially from location information determined by vehicle sensors and/or reliable data (e.g., map information contained in an onboard database). Some misbehavior detection mechanisms may be configured to detect reported vehicle dimension data that changes over time or differs from known values (e.g., in an onboard database). Some misbehavior detection mechanisms may be configured to detect substantial or erroneous drift in position information over time. Some misbehavior detection mechanisms may be configured to detect when reported locations (and potentially sizes) of reporting vehicles indicates that two vehicles overlap in space or another vehicle overlaps with own vehicle. Some methods may be configured to monitor speeds and acceleration information received in V2X messages from other vehicles to identify speeds inconsistent with current conditions, speeds inconsistent from moment to moment with reported accelerations using equations of motion, and the like. Some methods involve confirming whether sensor data, whether received from sensors internal to the vehicle or other-vehicle sensor data included in the misbehavior report, is implausible or inconsistent with normal or expected sensor data (e.g., outside the operating range of the sensor or inconsistent with limits imposed by surroundings).

Each of the various methods for detecting misbehavior conditions in vehicle-generated information or in received misbehavior reports may be implemented in separate algorithms, software modules, processing layers and/or processor or dedicated circuitry that may independently recognize or detect specific types or sources of misbehavior conditions. Some nonlimiting examples of misbehavior detection mechanisms include: mechanisms for identifying errors, inconsistencies or implausible information related to the location of the vehicle, the location of other vehicles, roadway objects and features, and other positional information which may be important for navigating the vehicle; mechanisms for identifying errors inconsistencies or implausible information related to velocities of the vehicle or other vehicles; mechanisms for identifying when the location information of other vehicles overlap or overlap with one another or the ego vehicle; mechanisms that identify when there is an unacceptable drift in position information of the vehicle or other vehicles; and mechanisms for identifying errors or inconsistencies in vehicle sensor data in parentheses e.g., conflicts with information received from other vehicles via V2X messages). For ease of reference, the various different methods, software modules and/or processors/circuitry are referred to herein as “plausibility and consistency detectors,” “misbehavior detection mechanisms” or simply “detectors.” In various embodiments, a vehicle V2X system may include any number or plurality of such detectors, and therefore such detectors may be referred to as detectors 1 to n, with any one detector referred to as “detector i.” References to methods, software and/components for identifying misbehavior conditions as “detectors,” as well as referring to detectors by number or letter, are not intended to limit the claims to particular types or configurations for identifying misbehavior conditions or to a particular number of such detectors.

Identifying misbehavior conditions within the vehicle and/or the ITS and reporting the conditions in misbehavior reports that can be processed by other vehicles and a Misbehavior Authority is important to minimize disruptions and safety challenges that such conditions could pose to all vehicles. However, transmitting too many misbehavior reports by V2X-equipped vehicles, particularly redundant reports, could overwhelm the available bandwidth for transmitting and receiving misbehavior reports in V2X communication channels. Similarly, the transmission of a large number of misbehavior reports addressing minor issues that do not require actions by other vehicles or the Misbehavior Authority would not make good use of the limited bandwidth for V2X communications, while making it more difficult for other vehicles to recognize critical misbehavior reports among many minor misbehavior reports. For these reasons, there is a need for V2X-equipped vehicles to aggregate misbehavior condition detections before confirming that a reportable and/or actionable misbehavior condition has been detected and generating a one or a few misbehavior reports rather than transmitting reports based on every detected misbehavior condition.

Various embodiments include methods and V2X communications processing and management system implementing the methods for aggregating misbehavior indications from one or more misbehavior detecting methods, modules and/or device of the vehicle, and identifying or determining that reportable or actionable misbehavior conditions exist based on the aggregation. Various embodiment methods may enable a vehicle V2X system to identify and act upon misbehavior conditions in a reliable manner while minimizing unnecessary and/or redundant misbehavior reports. In various embodiments, a vehicle V2X processing system may perform operations including receiving and/or detecting multiple indications of V2X misbehavior via one or more misbehavior detection mechanisms (i.e., methods, modules and/or detector device or circuitry), and aggregating the misbehavior indications output from the one or more misbehavior detection mechanisms to provide an aggregated output. The vehicle V2X processing system may use or process the aggregated output to determine whether a reportable or actionable misbehavior condition exists based on aggregated misbehavior indications. When a reportable or actionable misbehavior condition is identified, the V2X processing system may transmit a misbehavior report and/or take a responsive action in response to determining that a misbehavior condition exists.

Various types of aggregation methods may be implemented in various embodiments. In some embodiments, the V2X processing system may aggregate misbehavior indications output from misbehavior detection mechanisms by determining whether any of the one or more misbehavior detection mechanisms outputs a misbehavior indication. For example, the conclusions or outputs from multiple misbehavior detection mechanisms (i.e., algorithms, modules and/or devices) may be coupled to an OR gate that functions as an aggregator, such that if any one of the multiple misbehavior detection mechanisms produces or outputs a misbehavior indication, the aggregator module outputs a misbehavior indication or detection to a misbehavior condition determination module or function in the V2X processing system. In such embodiments, the V2X processing system may determine that a reportable or actionable misbehavior condition exists in response to determining that at least one of the misbehavior detection mechanisms outputs a misbehavior indication. Thus, any one misbehavior indication by one or more of the plurality of misbehavior detection mechanisms may result in a determination by the V2X processing system that a misbehavior condition exists for which a report (i.e., a misbehavior report) should be transmitted and/or a responsive action should be taken.

In some embodiments, the V2X processing system may aggregate misbehavior indications produced or output from the one or more misbehavior detection mechanisms by determining whether any one of a selected subset of the misbehavior detection mechanisms outputs a misbehavior indication. For example, the conclusions or outputs from the selected subset of misbehavior detection mechanisms (i.e., algorithms, modules and/or devices) may be coupled to an OR gate that functions as an aggregator, such that if any one of the selected misbehavior detection mechanisms produces or outputs a misbehavior indication, the aggregator module outputs a misbehavior indication or detection to the misbehavior condition determination module or function in the V2X processing system. Other misbehavior detection mechanisms may be aggregated according to some of the other embodiments disclosed herein, such as counted and compared to a threshold (e.g., a majority number), or assigned weights depending upon the type of detection mechanism with weighted indications provided to the misbehavior condition determination module or function. In such embodiments, the V2X processing system may determine that a reportable or actionable misbehavior condition exists in response to determining that at least one of the selected subset of misbehavior detection mechanisms outputs a misbehavior indication.

In some embodiments, the V2X processing system may aggregate misbehavior indications output from the one or more misbehavior detection mechanisms and output (e.g., to the misbehavior condition determination module or function) the number of indications received from misbehavior detection mechanisms corresponding a particular misbehavior condition. In such embodiments, the V2X processing system may determine that a reportable or actionable misbehavior condition exists in response to number of misbehavior indications satisfying a threshold number. In some embodiments, comparing the number of misbehavior conditions to a threshold number may involve determining whether a majority of the misbehavior detection mechanisms have output misbehavior indications.

In some embodiments, aggregating misbehavior indications by the V2X processing system may include applying a respective weight to outputs of each of the one or more misbehavior detection mechanisms, and aggregating the weighted outputs of the one or more misbehavior detection mechanisms. For example, the V2X processing system may assign a weight to a misbehavior indication from a particular detection mechanism depending upon the source or sensor used in detecting misbehaviors. In such embodiments, the V2X processing system may determine that a reportable and/or actionable misbehavior condition exists in response to the weighted outputs of misbehavior detection mechanisms exceeding a threshold, which may be predefined or dependent on operating circumstances or context. In some embodiments, the weights assigned to any given misbehavior detection mechanism or misbehavior indication may be preset or predetermined. In some embodiments, the weights assigned to any given misbehavior detection mechanism or misbehavior indication may be changed or updated by the V2X processing system depending on various conditions, changed or updated by an authority (e.g., a Misbehavior Authority) via an over-the-air update.

In some embodiments, the V2X processing system may be configured to adjust the sensitivity or detection thresholds or various misbehavior detection mechanisms so as to achieve a level of sensitivity without producing excessive numbers of misbehavior reports. In such embodiments, the V2X processing system may process misbehavior indications received from a plurality of plausibility and consistency detectors that are configured to detect misbehavior conditions using a detector selector that is configured to select particular detectors whose outputs will be evaluated as part of recognizing misbehavior conditions. In such embodiments, aggregating misbehavior indications may include the detector selector passing outputs of misbehavior indications from a selected subset of the plurality of misbehavior detection mechanisms to a misbehavior detector that is configured to determine whether a reportable or actionable misbehavior condition exists based on indications from the selected subset of the plurality of plausibility and consistency detectors. In such embodiments, the V2X processing system may also determine whether the rate of misbehavior determinations by the system (e.g., number of misbehavior determinations made per unit time) exceeds a maximum threshold rate or is less than a minimum threshold rate. The V2X processing system may then deactivate one or more sensitive plausibility and consistency detectors in response to determining that the rate of misbehavior determinations exceeds the maximum threshold, or activate one or more sensitive plausibility and consistency detectors in response to determining that the rate of misbehavior determinations is less than the minimum threshold. In this manner, the V2X processing system can dynamically adjust the sensitivity of misbehavior detections so that the rate at which the system reports or acts upon misbehavior determinations remains within a predefined range between the maximum rate and the minimum rate.

In some embodiments, as part of aggregating outputs from multiple misbehavior detection mechanisms, the V2X processing system may determine the number of events that are classified as an attack or a misbehavior indication in the outputs of each of the misbehavior detection mechanisms within a window of time or set number of events. For example, misbehavior detection mechanisms may be configured to indicate whether a misbehavior has been detected periodically (e.g., once per second), such as indicating whether misbehavior has been detected or not detected in the intervening period or output cycle. In such configurations, the fee 2X processing system may monitor the outputs from each of them multiple misbehavior detection mechanisms over a predetermined time window (e.g., 10 seconds, 30 seconds, one minute, etc.) or a set number of output cycles, tallying or otherwise keeping track of the number of outputs that indicate a misbehavior detection. In such embodiments, the V2X processing system may determine when a reportable or actionable misbehavior condition exists based on the count of positives misbehavior indications (i.e., indications of an attack or misbehavior) by any one misbehavior detection mechanism within the time window. For example, that V2X processing system may determine that a reportable or actionable misbehavior condition exists when the number of events classified as an attack or misbehavior indications output by any one of the plurality of misbehavior detection mechanisms within the time window or set number of output cycles exceeds a threshold, such as a majority of the outputs during the time window or set number of output cycles.

In some embodiments, the particular type of aggregator or aggregators implemented in a V2X processing system may be changed or implemented based upon various conditions, such as traffic volume, driving location, time of day, day of week, and other factors.

Various embodiments improve the functioning of V2X communications processing and management system and V2X communications by aggregating misbehavior indications and determining whether to report or act upon a misbehavior condition determination based on the aggregations, thereby reducing the transmission of redundant, spurious or low criticality misbehavior reports, which may improve the use of limited V2X communication bandwidth while ensuring that important or critical misbehavior reports are transmitted and/or acted upon.

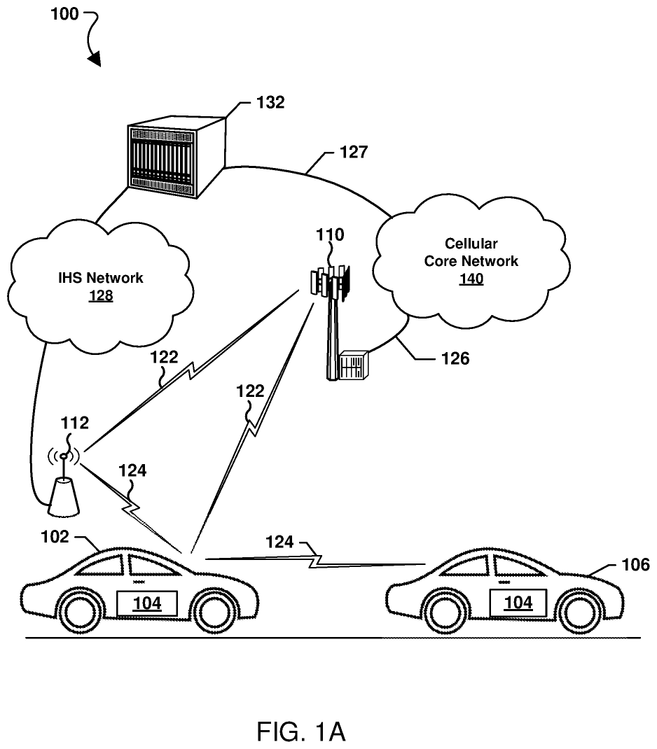

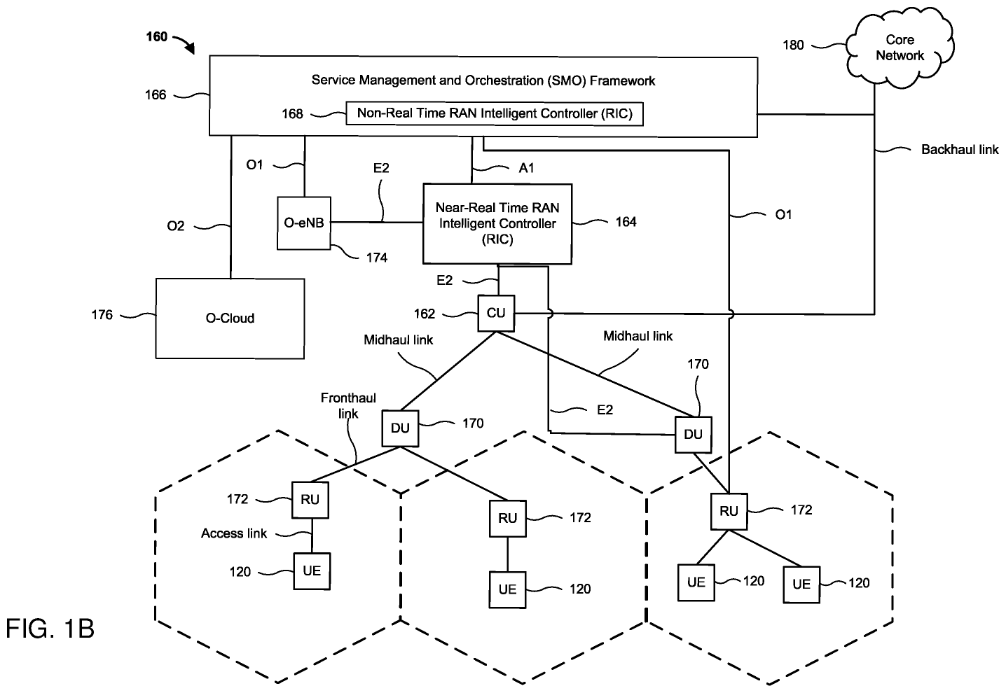

FIG. 1A is a system block diagram illustrating an example communication system 100 suitable for implementing the various embodiments. The illustrated example communications system 100 include a 5G New Radio (NR) network, an ITS V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including a vehicle 102 equipped with an ADS 104 including wireless communication capabilities. The base station 110 may communicate with a core network 140 over a wired network 126. The communications system 100 also may include road side units 112 supporting V2X communications with vehicles 102 via V2X wireless communication links 124.

A base station 110 is a network element that communicates with wireless devices (e.g., the vehicle 102) via, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Road side units may be coupled via wired networks 128 to a remote computing device 132 that hosts a Misbehavior Authority (Misbehavior Authority). Roadside units 112 may communicate via V2X wireless communication links 124 with ITS and V2X-equipped vehicles 102 for downloading information useful for safe operations, including receiving information regarding V2X misbehavior conditions that have been reported by other vehicles and logged and reported by the Misbehavior Authority.

Cellular wireless communication networks, such as 5G wireless communication networks, supported by base stations 110 may also be used for V2X communications in some implementations and situations. For example, in some locations and implementations, a 5G wireless communication network may be used by a V2X communications processing and management system for transmitting misbehavior reports to a Misbehavior Authority and receiving information regarding misbehavior conditions from the Misbehavior Authority. To support such communications, the Misbehavior Authority may be coupled to the core network via a communication link 127, such as the Internet, and map data and confidence information may be communicated to a base station 110 via a wired communication link 126 (e.g., Ethernet, fiber optic, etc.) for downloading to vehicles 102 via cellular wireless communication links 122 such as 5G wireless communication links.

Cellular wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network suitable for communicating V2X messages and misbehavior condition information. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a vehicle ADS system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit—User Plane (CU-UP)), control plane functionality (i.e., Central Unit—Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

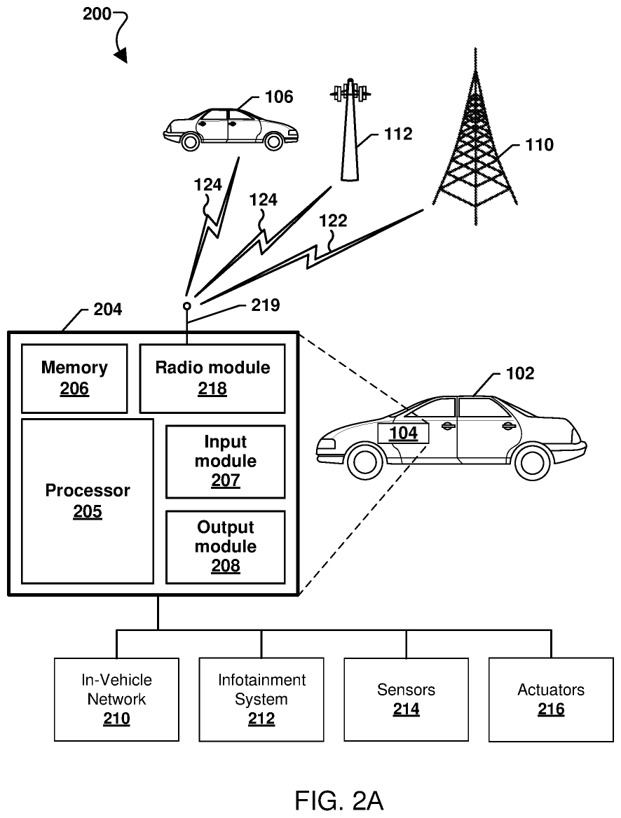

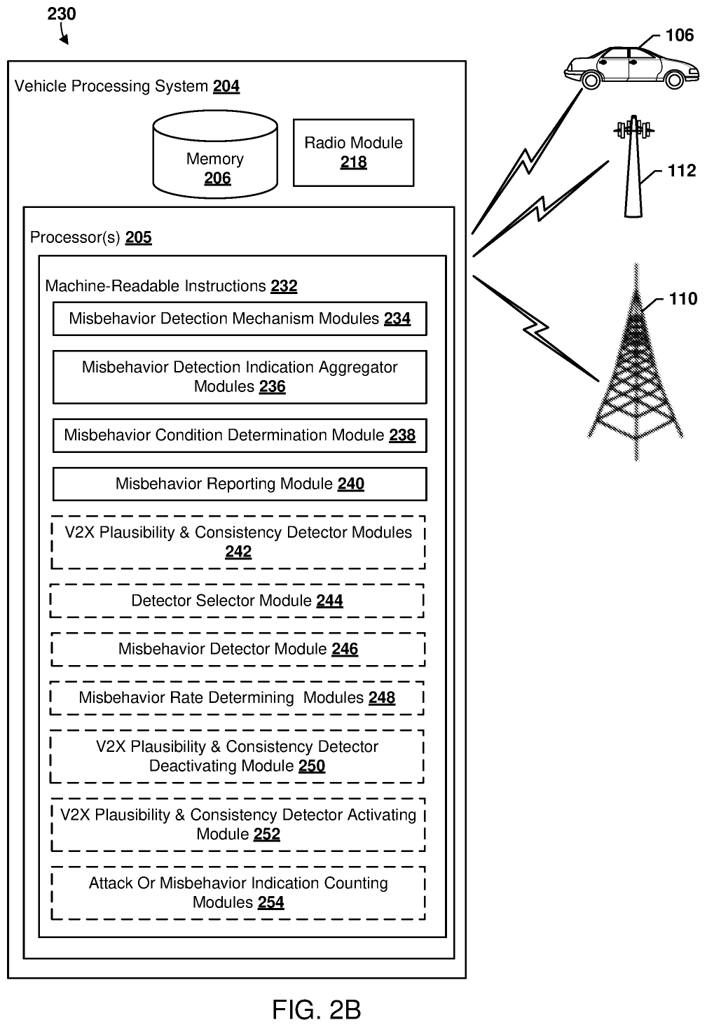

FIG. 2A is a component diagram of an example vehicle V2X communications system 200 suitable for implementing various embodiments. With reference to FIGS. 1A-2A, the system 200 may include a vehicle 102 that includes a vehicle V2X communications processing and management system 104. The V2X communications processing and management system 104 may communicate with various systems and devices, such as an in-vehicle network 210, an infotainment system 212, various sensors 214, various actuators 216, and a radio module 218 coupled to an antenna 219. The V2X communications processing and management system 104 also may communicate with roadside units 112, cellular communication network base stations 110, and other external devices.

The vehicle V2X communications processing and management system 204 may include a processor 205, memory 206, an input module 207, an output module 208 and the radio module 218. The processor 205 may be coupled to the memory 206 (i.e., a non-transitory storage medium), and may be configured with processor-executable instructions stored in the memory 206 to perform operations of the methods according to various embodiments described herein. Also, the processor 205 may be coupled to the output module 208, which may control in-vehicle displays, and to the input module 207 to receive information from vehicle sensors as well as driver inputs.

The vehicle V2X communications processing and management system 204 may include a V2X antenna 219 coupled to the radio module 218 that is configured to communicate with one or more ITS participants, such as another V2X-equipped vehicle 106, a roadside unit 112, and a base station 110 or another suitable network access point. The V2X antenna 219 and radio module 218 may be configured to support V2X communication networks. In various embodiments, the vehicle V2X communications processing and management system 204 may receive information from a plurality of information sources, such as the in-vehicle network 210, infotainment system 212, various sensors 214, various actuators 216, and the radio module 218. The vehicle V2X communications processing and management system processor 205 may be configured to perform operations including receiving and detecting indications of misbehavior and apply aggregators to such detections before reporting or acting upon determined misbehavior conditions.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network. Examples of vehicle sensors 214 include a location determining system (such as a Global Navigation Satellite Systems (GNSS) system, cameras, radar, lidar, ultrasonic sensors, infrared sensors, and other suitable sensor devices and systems. Examples of vehicle actuators 216 include various physical control systems such as for steering, brakes, engine operation, lights, directional signals, and the like.

FIG. 2B is a component block diagram illustrating elements of a vehicle ADS 230 configured in accordance with various embodiments. With reference to FIGS. 1A-2B, the vehicle ADS 230 may include a vehicle V2X communications processing and management system 204 of a vehicle (e.g., 102), which may be configured to communicate with a roadside unit 112, and/or a cellular network base station 110.

The vehicle V2X communications processing and management system 204 may include one or more processors 205, memory 206, a radio module 218), and other components. The vehicle V2X communications processing and management system 204 may include a plurality of hardware, software, and/or firmware components operating together to provide the functionality attributed herein to the processor 205.

The memory 206 may include non-transitory storage media that electronically stores information. The electronic storage media of memory 206 may include one or both of system storage that is provided integrally (i.e., substantially non-removable) with the vehicle V2X communications processing and management system 204 and/or removable storage that is removably connectable to the vehicle V2X communications processing and management system 204 via, for example, a port (e.g., a universal serial bus (USB) port, a firewire port, etc.) or a drive (e.g., a disk drive, etc.). In various embodiments, memory 206 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The memory 206 may include one or more virtual storage resources (e.g., cloud storage, a virtual private network, and/or other virtual storage resources). Memory 206 may store software algorithms, information determined by processor(s) 205, information received from the one or more other vehicles 220, information received from the roadside unit 112, information received from the base station 110, and/or other information that enables the vehicle V2X communications processing and management system 204 to function as described herein.

The processor(s) 205 may include one of more local processors that may be configured to provide information processing capabilities in the vehicle V2X communications processing and management system 204. As such, the processor(s) 205 may include one or more of a digital processor, an analog processor, a digital circuit designed to process information, an analog circuit designed to process information, a state machine, and/or other mechanisms for electronically processing information. Although the processor(s) 205 is shown in FIG. 2A as a single entity, this is for illustrative purposes only. In some embodiments, the processor(s) 205 may include a plurality of processing units. These processing units may be physically located within the same device, or the processor(s) 205 may represent processing functionality of a plurality of devices distributed in the vehicle and operating in coordination.

The vehicle V2X communications processing and management system 204 may be configured by machine-readable instructions 232, which may include one or more instruction modules. The instruction modules may include computer program modules. In various embodiments, the instruction modules may include one or more of misbehavior detection mechanism modules 234, a misbehavior detection indication aggregator module 236, a misbehavior condition determination module 238, and misbehavior reporting module 240. In some embodiments, the instruction modules may further include one or more of V2X plausibility and consistency detector modules 242, a detector selector module 244, a misbehavior detection module 246, a misbehavior rate determining module 248, a V2X plausibility and consistency detector deactivating module 250, V2X plausibility and consistency detector activating module 252, and attack or misbehavior indication counting modules 254.

In various embodiments, the processor 205 executing the misbehavior detection mechanism modules 234 may detect multiple indications of V2X misbehavior via one or more misbehavior detection mechanisms. For example,

In various embodiments, the processor 205 executing the misbehavior detection indication aggregator 236 may aggregate misbehavior indications output from the one or more misbehavior detection mechanisms. In some embodiments, the processor 205 executing the misbehavior detection indication aggregator 236 may determine whether any of the one or more misbehavior detection mechanisms outputs a misbehavior indication. In some embodiments, the processor 205 executing the misbehavior detection indication aggregator 236 may determine whether any one of a select subset of the one or more misbehavior detection mechanisms outputs a misbehavior indication. In some embodiments, the processor 205 executing the misbehavior detection indication aggregator 236 may aggregate misbehavior indications output from multiple misbehavior detection mechanisms. In some embodiments, the processor 205 executing the misbehavior detection indication aggregator 236 may apply a respective weight to outputs of each of the one or more misbehavior detection mechanisms, and aggregate the weighted outputs of the one or more misbehavior detection mechanisms. In some embodiments, the weights assigned to any given misbehavior detection mechanism or misbehavior indication may be preset or predetermined. In some embodiments, the weights assigned to any given misbehavior detection mechanism or misbehavior indication may be changed or updated by the V2X processing system depending on various conditions, changed or updated by an authority (e.g., a Misbehavior Authority) via an over-the-air update.

In some embodiments, the processor 205 executing the misbehavior detection indication aggregator 236 may pass outputs of misbehavior indications from a selected subset of the plurality of detectors from the detector selector 244 to the misbehavior detector module 246. In some embodiments, the processor 205 executing the misbehavior detection indication aggregator 236 may determine a number of events classified as an attack or misbehavior indications output by each of a plurality of misbehavior detection mechanisms within a window of time or set number of events.

In various embodiments, the processor 205 executing the misbehavior condition determination module 238 may determine whether a reportable or actionable misbehavior condition exists based on aggregated misbehavior indications. In some embodiments, the processor 205 executing the misbehavior condition determination module 238 may determine that a reportable or actionable misbehavior condition exists in response to determining that at least one of the misbehavior detection mechanisms outputs a misbehavior indication. In some embodiments, the processor 205 executing the misbehavior condition determination module 238 may determine that a reportable or actionable misbehavior condition exists in response to determining that at least one of the select subset of misbehavior detection mechanisms outputs a misbehavior indication. In some embodiments, the processor 205 executing the misbehavior condition determination module 238 may determine that a reportable or actionable misbehavior condition exists in response to a threshold number of the misbehavior detection mechanisms outputting misbehavior indications. In some embodiments, the processor 205 executing the misbehavior condition determination module 238 may determine that a reportable or actionable misbehavior condition exists in response to a majority of the misbehavior detection mechanisms outputting misbehavior indications. In some embodiments, the processor 205 executing the misbehavior condition determination module 238 may determine that a reportable or actionable misbehavior condition exists in response to the weighted outputs of misbehavior detection mechanisms exceeding a threshold. In some embodiments, the processor 205 executing the misbehavior condition determination module 238 may determine that a reportable or actionable misbehavior condition exists in response to misbehavior indication outputs by the selected subset of the plurality of plausibility and consistency detectors 242. In some embodiments, the processor 205 executing the misbehavior condition determination module 238 may determine that a reportable or actionable misbehavior condition exists in response to determining that the number of events classified as an attack or misbehavior indications output by any one of the plurality of misbehavior detection mechanisms within the window of time or set number of events exceeds a threshold.

In various embodiments, the processor 205 executing the misbehavior reporting module 240 may transmitting a misbehavior report or taking a responsive action in response to determining that a misbehavior condition exists. For example,

In some embodiments, the processor 205 executing the V2X plausibility and consistency detector modules 242 may detect misbehavior conditions and output misbehavior indications to a detector selector. For example,

In some embodiments, the processor 205 executing the detector selector module 244 may select all a subset of V2X plausibility and consistency detectors or detector modules 242 for passing misbehavior detection outputs to the misbehavior detector 246.

In some embodiments, the processor 205 executing the misbehavior detector 246 may determine that a reportable or actionable misbehavior condition exists in response to misbehavior indication outputs by the selected subset of the plurality of plausibility and consistency detectors.

In some embodiments, the processor 205 executing the misbehavior rate determining module 248 may determine the rate of misbehavior determinations output by the misbehavior condition determination module 238.

In some embodiments, the processor 205 executing the V2X plausibility and consistency detector deactivating modules 250 may deactivating one or more of the sensitive plausibility and consistency detectors 242 in response to determining that the rate of misbehavior determinations by the misbehavior condition determination module 238 exceeds the maximum threshold (X). For example,

In some embodiments, the processor 205 executing the V2X plausibility and consistency detector activating modules 252 may activating one or more sensitive plausibility and consistency detectors 242 in response to determining that the rate of misbehavior determinations by the misbehavior condition determination module 238 is less than the minimum threshold (Y).

In some embodiments, the processor 205 executing the attack or misbehavior indication counting modules 254 may determine a number of events classified as an attack or misbehavior indications output by each of a plurality of misbehavior detection mechanisms within a window of time or set number of events. For example,

The processor(s) 205 may execute the modules 232-254 and/or other modules by software, hardware, firmware, some combination of software, hardware, and/or firmware, and/or other mechanisms for configuring processing capabilities on processor(s) 205.

The description of the functionality provided by the different modules 232-244 is for illustrative purposes, and is not intended to be limiting, as any of modules 232-244 may provide more or less functionality than is described. For example, one or more of modules 232-244 may be eliminated, and some or all of its functionality may be provided by other ones of modules 232-244. As another example, processor(s) 205 may execute one or more additional modules that may perform some or all of the functionality attributed below to one of modules 232-244.

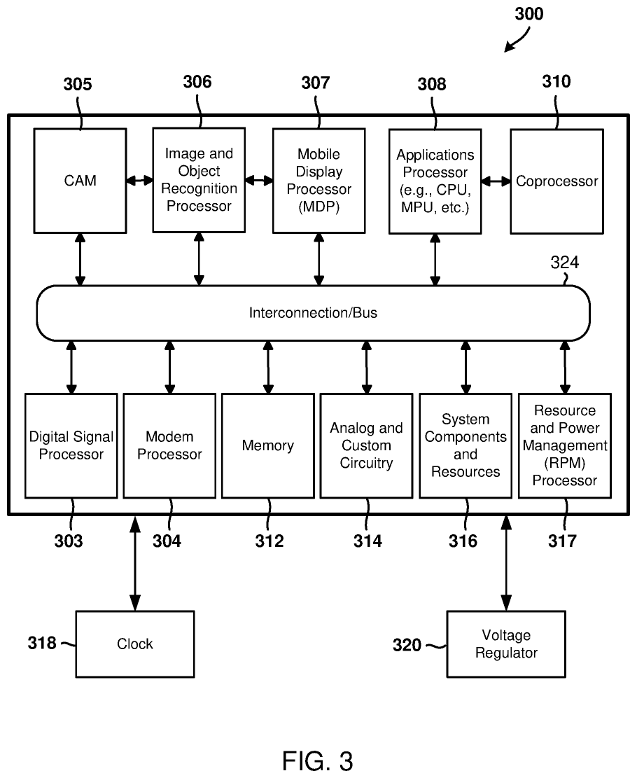

FIG. 3 illustrates an example system-on-chip (SOC) architecture of a processing device SOC 300 suitable for implementing various embodiments in vehicles. With reference to FIGS. 1A-3, the processing device SOC 300 may be included in a vehicle V2X processing system for use in a vehicle 102.

The processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317.

Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations for performing V2X communications. For example, such specialized operations may include identifying implausible and/or inconsistent information in V2X messages (e.g., sensor data that conflicts with information in a received V2X message) that may be indicative of misbehavior by another vehicle or in another vehicle sensor or internal system, as well as implausible and/or inconsistent vehicle sensor data that may be indicative of misbehavior in a vehicle sensor or internal system.

The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a vehicle V2X processing system (e.g., 104, 204).

The processing device SOC 300 also include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras (e.g., 158, 160) via the CAM 305 to recognize and/or identify other vehicles, and otherwise perform functions of the camera perception layer 224 as described. In some embodiments, the processor 306 may be configured to process radar or lidar data and perform functions of the radar and/or lidar perception layer 222 as described.

The system components and resources 316, analog and custom circuitry 314, and/or CAM 305 may include circuitry to interface with peripheral devices, such as cameras radar, lidar, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, Global Positioning System (GPS) receivers, communications circuitry (e.g., Bluetooth®, WLAN, WiFi, etc.), and other well-known components of modern electronic devices.

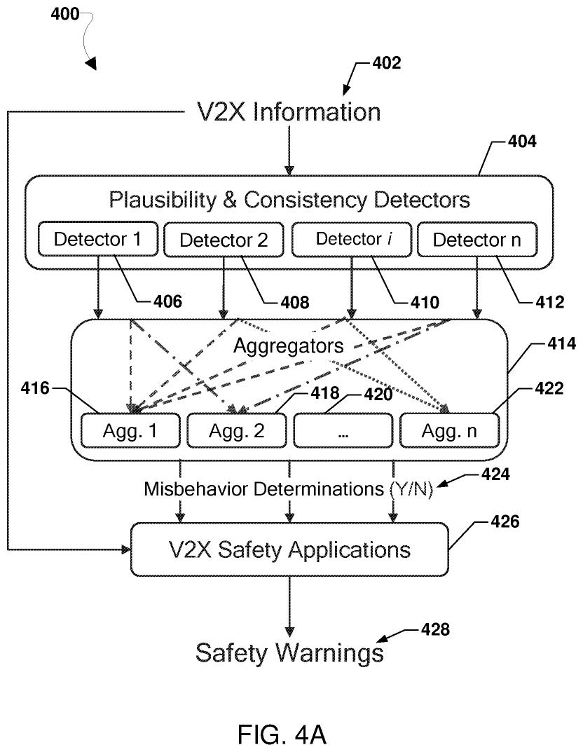

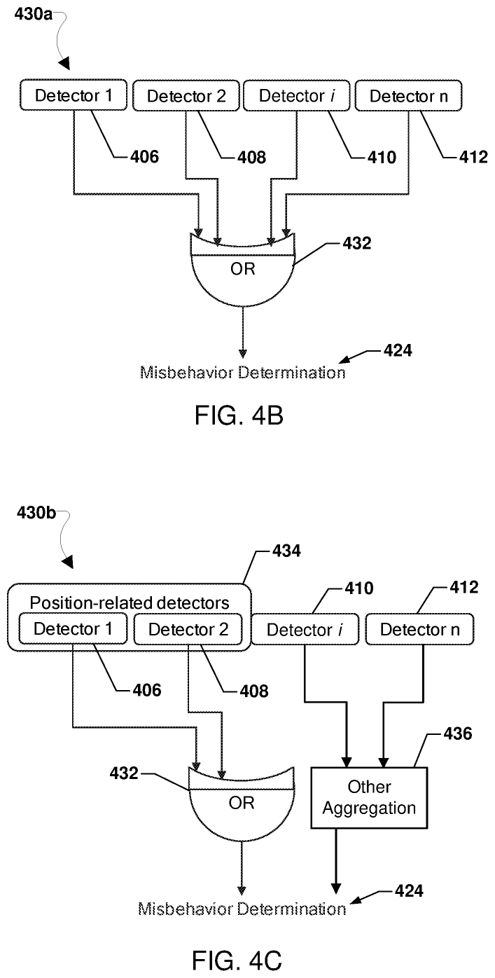

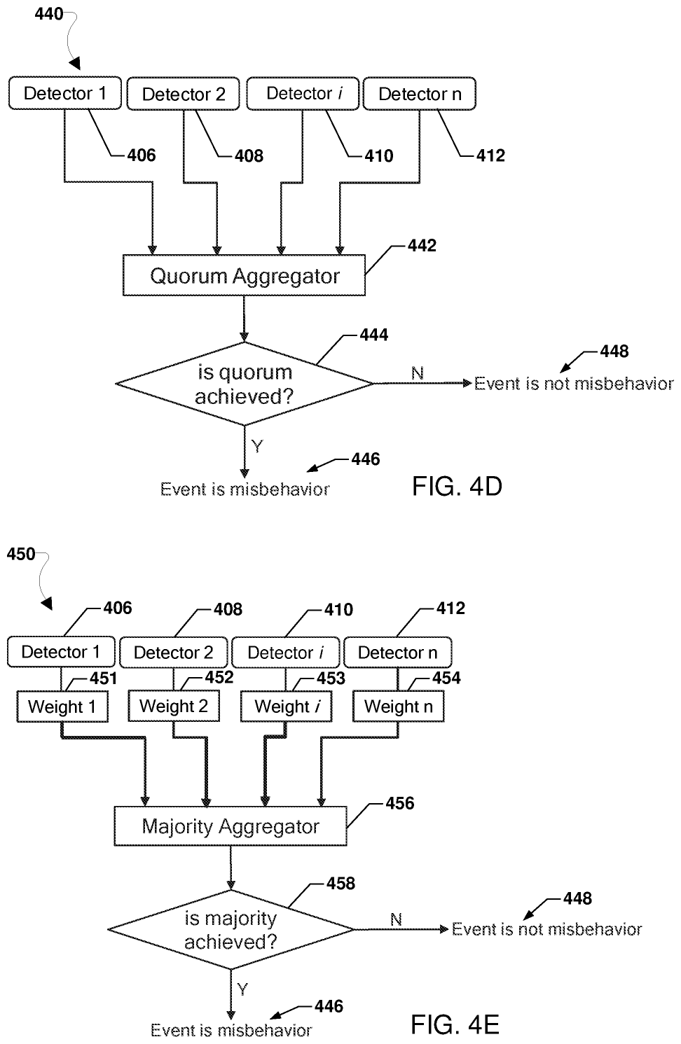

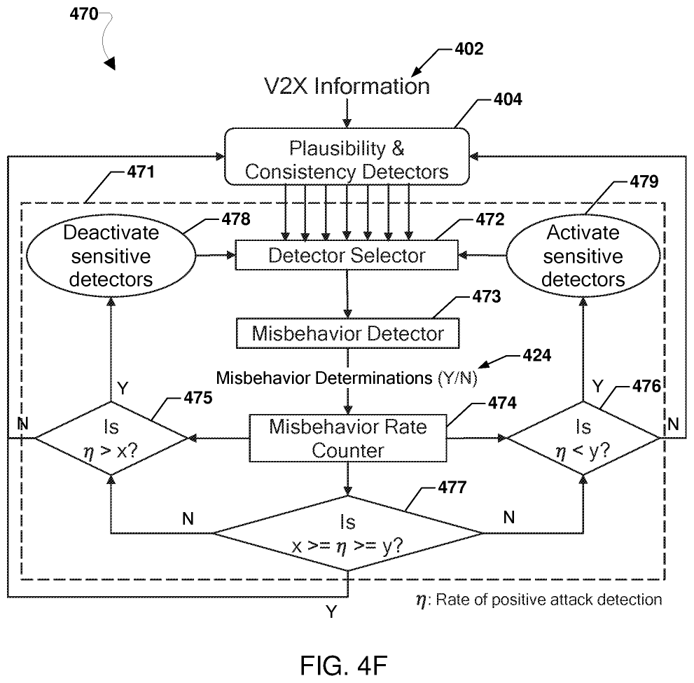

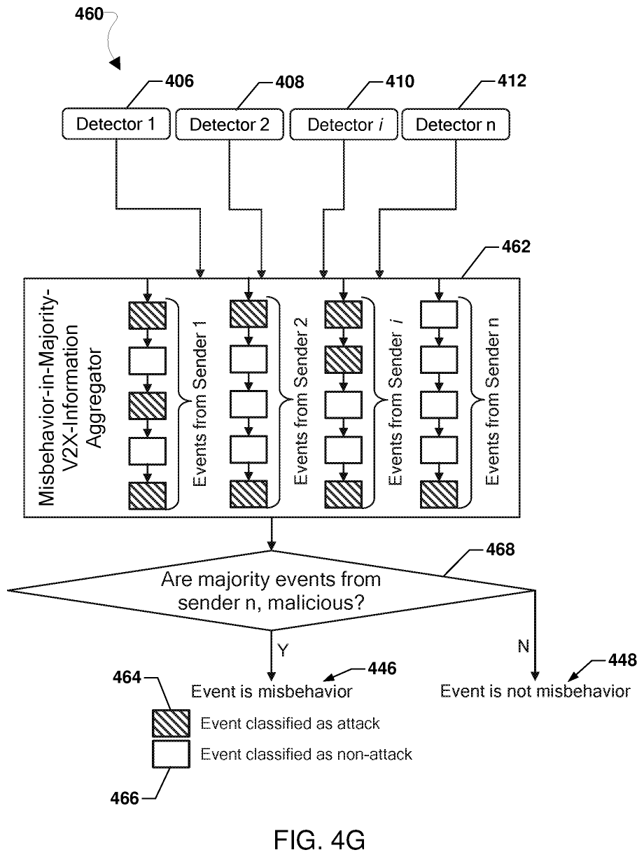

FIGS. 4A-4G are processing module and process flow diagrams illustrating different systems and processes for aggregating misbehavior indications and using aggregated misbehavior indications to determine whether a reportable or actionable misbehavior condition exists before transmitting misbehavior reports and/or determining that one or more misbehavior indications should be acted upon.

FIG. 4A is a functional block diagram of a V2X aggregator system 400 according to various embodiments for detecting V2X misbehavior events, aggregating V2X misbehavior indications, and transmitting/acting on determined misbehavior conditions. With reference to FIGS. 1A-4A, in various embodiments, a V2X processing system may receive V2X information 402 via BSMs and other V2X messages from other vehicles and road side units, such as the location, speed and directions of other vehicles, roadway conditions (e.g., traffic conditions, accident notifications, etc.). While such information is useful to and used by V2X safety applications 426, the information may also be processed by multiple plausibility and consistency detectors 404, which may be made up of a number detector mechanisms, illustrated as “detector 1” 406, “detector 2” 408, “detector i” 410, and “detector n” 412. Each of the multiple detector mechanisms 406-412 may be configured to assess a particular type of information from a particular source and recognize or detect a misbehavior, error or inconsistency, such as by comparing the received information to data obtained from particular vehicle information sources, including data stored in memory and sensor data.

A misbehavior condition determining module 414 may use multiple aggregators 416, 418, 420, 422 implementing different aggregation methods, including aggregation methods of various embodiments described herein, to determine whether one or more misbehavior conditions exist. Additionally, the misbehavior condition determining module 414 may use outputs from the multiple aggregators 416, 418, 420, 422 to make different types of misbehavior determinations 424 consistent with particular misbehavior detection mechanisms (e.g., one or more of detector mechanisms 406-412) and particular aggregator output used in making misbehavior determinations 424.

In some embodiments, multiple aggregators 416-422 may receive and aggregate misbehavior indications from a respective one of the detector mechanisms 406-412 to make misbehavior determinations 424. In such embodiments there may be a one-to-one correlation between a given aggregator and a corresponding detector mechanism. In this manner, the aggregation method used by a given aggregator may be appropriate for the type of misbehavior detected, the sources of information used, or precision or reliability of the corresponding detection mechanism.

In some embodiments, outputs from the various detector mechanisms 406-412 may be processed by one or more aggregators 416, 418, 420, 422, and the misbehavior condition determining module 414 414 may use outputs from multiple aggregators 416, 418, 420, 422 coupled to detector mechanisms 406-412 to make misbehavior determinations 424. For example, as illustrated in FIG. 4A, “aggregator 1” 416 may receive and process misbehavior indications output by all detector mechanisms 406-412 while “aggregator 2” 418 may receive and process misbehavior indications output by “detector 1” 406 and “detector n” 412. The different aggregators 416-422 may process inputs from multiple detector mechanisms 406-412 using different aggregation methods appropriate for the types of misbehavior indications received and processed.

The misbehavior condition determining module 414 may output different types of misbehavior determinations 424 depending on the outputs processed from various detectors 406-412 and various aggregators 416-422, as well as corresponding decision criteria used to identify or confirm a misbehavior condition. As an example consider the case of processing information output from the Emergency Electronic Brake Light (EEBL) application, which is one of the V2X safety applications. The EEBL application enables a vehicle to broadcast a self-generated emergency brake event to surrounding vehicles via V2X messages. A detector (e.g., one of 406-412) may compare information received in an EEBL V2X message to other vehicle sensor information, such as from radar, lidar and cameras, to check whether the remote vehicle sending such a V2X message is exhibiting high deceleration consistent with emergency braking. Additionally, the detector may determine whether the braking condition of the remote vehicle is relevant to its vehicle (i.e., the “ego vehicle”), such as by determining whether the remote vehicle is in the same lane as the ego vehicle and is within a certain safety distance, such as 100 meters. Thus, in this example, the misbehavior condition determining module 414 making a misbehavior determination based on information related to an EEBL event may rely on acceleration and position information to determine whether to raise a warning by issuing a misbehavior determination 424. Hence, in the case of an EEBL event, the misbehavior condition determining module 414 may use outputs from an acceleration-related aggregator and a position-related aggregator, such as illustrated in FIG. 4C.

Misbehavior determinations 424 may be provided to the V2X safety applications 426 for action. In some cases, the V2X safety applications 426 may issue safety warnings 428, such as by transmitting misbehavior reports, generating internal warnings for the driver. In some cases, the V2X safety applications 426 may take actions to ensure safe operation of the vehicle, such as ignoring V2X information that is determined to be in error, or taking an action to avoid a dangerous situation in response to determining that the determined misbehavior requires a safety action.

FIG. 4B illustrates an example embodiment of a V2X aggregator system 430a for aggregating V2X misbehavior indications and determining whether a reportable or actionable misbehavior condition exists based on the aggregated misbehavior indications. With reference to FIGS. 1A-4B, in some embodiments, one or more of the misbehavior detection mechanisms 406-412, may function as or similar to an OR gate 432. In such embodiments, one or more of the misbehavior detection mechanisms 406-412 may be configured to provide misbehavior indications (e.g., an indication that a misbehavior has been detected) to the OR gate 432, which may be configured to determine that a misbehavior condition exists and issue a misbehavior determination 424 in response to any of the connected misbehavior detection mechanisms 406-412 providing a misbehavior indication.

The use of an OR function as an integrator, as illustrated in FIG. 4B, may be applied to some but not all of the various misbehavior detection mechanisms 406-412. With reference to FIGS. 1A-4C, FIG. 4C illustrates an embodiment of a V2X aggregator system 430b for aggregating V2X misbehavior indications in which some of the misbehavior detection mechanisms (e.g., detectors 406, 408) are aggregated in an OR gate 432 while other misbehavior detection mechanisms (e.g., detectors 410, 412) are aggregated using other types of aggregation 436, including aggregators described herein. For example, the OR gate 432 aggregator may aggregate misbehavior indications from position-related detectors 434 (e.g., detectors 406, 408) that identify position-related errors or misbehaviors (e.g., implausible and/or inconsistent V2X information), and output a misbehavior determination 424 if any one of such detectors identifies a misbehavior condition.

FIG. 4D illustrates another embodiment of a V2X aggregator system 440 for aggregating V2X misbehavior indications and determining whether a reportable or actionable misbehavior condition exists based on aggregation of misbehavior indications across a number of misbehavior detection mechanisms (shown as detectors 406-412). With reference to FIGS. 1A-4D, in some embodiments, aggregation of V2X misbehavior indications may be accomplished by an aggregator 442 (shown as a “quorum aggregator”) that receives misbehavior indication outputs from a plurality of misbehavior detection mechanisms 406-412 and determines in determination block 444 whether a predefined threshold number, or quorum threshold, of the detectors are providing or provided the same or substantiating misbehavior indications, generating an output 446 to the V2X processing equipment a determination that a detected event constitute misbehavior. In some embodiments, the quorum aggregator 442 may receive misbehavior indications from various misbehavior detection mechanisms or detectors 406-412, keep track of the received misbehavior indications to identify events reported by the indications, and effectively count the number of indications within a predefined interval of time (e.g., one second, 10 seconds, etc.) that are associated with a same event, before comparing that count to the quorum threshold in determination block 444.

The quorum threshold against which the number of misbehavior indications our compared may be any preset value greater than one, and may be adjusted dynamically based on operating conditions, such as a rate of this behavior event detections. Further, the quorum aggregator 442 may be coupled to some but not all misbehavior detection mechanisms or detectors 406-412 within a vehicle V2X system, in which case the aggregated number of misbehavior indications that is compared to the quorum threshold may be a subset of the mechanisms or detectors. For example, the quorum aggregator 442 may be coupled to those misbehavior detection mechanisms or detectors 406-412 that are not coupled to an OR aggregator 432, such as illustrated in FIG. 4C.

FIG. 4E illustrates another embodiment of a V2X aggregator system 450 for aggregating V2X misbehavior indications and determining whether a reportable or actionable misbehavior condition exists based on the aggregated misbehavior indications. With reference to FIGS. 1A-4E, in some embodiments, a weighted aggregation of misbehavior indications from multiple misbehavior detection mechanisms or detectors 406-412 may be performed by a majority aggregator 456. In such embodiments, the misbehavior indication outputs by each of the misbehavior detection mechanisms or detectors 406-412 may be assigned a respective weight 451, 452, 453, 454, and the weighted indication may be aggregated by the majority aggregator 458. The majority aggregator 458 may compare the result of aggregating the weighted indications to a threshold in determination block 458. In response to determining that the weighted indications satisfies or exceeds the threshold, the majority aggregator 458 may output a misbehavior determination 446 to the V2X processing equipment, and may output nothing or a determination 448 that an event is not misbehavior. In some embodiments, the weights 451-454 applied to misbehavior indications output by the multiple misbehavior detection mechanisms or detectors 406-412 may be predetermined, such as by a Misbehavior Authority during an over-the-air update or provisioning. In some the weights 451-454 applied to misbehavior indications output by the multiple misbehavior detection mechanisms or detectors 406-412 may be determined or adjusted dynamically, such as by a Misbehavior Authority during an over-the-air update or provisioning, by the vehicle V2X processing equipment based on a rate of determined misbehavior conditions, and other considerations.

FIG. 4F illustrates another embodiment 470 for aggregating V2X misbehavior indications and determining whether a reportable or actionable misbehavior condition exists based on the aggregated misbehavior indications. With reference to FIGS. 1A-4F, in some embodiments, a plurality of plausibility and consistency detectors 404 may provide a plurality outputs to an aggregator system 471, which may include a detector selector 472, a misbehavior detector 473, a misbehavior rate counter 474, a comparators 475, 476, 477 for comparing misbehavior rates to maximum and minimum thresholds, circuitry or an algorithm 478 configured to deactivate sensitive detectors in the detector selector 472 when misbehavior rates exceed the maximum threshold, and circuitry or an algorithm 479 configured to activate sensitive detectors in the detector selector 472 when misbehavior rates are less than the maximum threshold. Such elements of the aggregator system 471 may be implemented in software as algorithms, software modules, dedicated circuitry, and/or combinations of circuitry (e.g., dedicate processors) and software. Such an aggregator 471 enables the vehicle V2X processing equipment to change the plausibility and consistency detectors 404 used to detect misbehaviors conditions so as to maintain the rate of misbehavior event detections between maximum and minimum threshold rates.

In such embodiments, the vehicle V2X processing equipment may include multiple plausibility and consistency detectors 404 (e.g., detection mechanism, software modules, and/or devices) that process information received from V2X communications from other vehicles, road side units, etc., vehicle sensors, information obtained from on-vehicle memory (e.g., in databases containing map information, information regarding other types of vehicles, and the like), and other sources to identify inconsistent reports, implausible results (e.g., information that conflicts with known information or physics), and other indications of possible misbehavior within the vehicle, other vehicles, or the intelligent highway system.

Outputs from the multiple plausibility and consistency detectors 404 may be selected or filtered by the detector selector 472 that may be configured to pass misbehavior indications from selected ones of the multiple plausibility and consistency detectors 404 to the misbehavior detector 473. The plausibility and consistency detectors 404 that are passed to the misbehavior detector 473 may be adjusted by inputs from the module or device for deactivating sensitive detectors 478 and activating sensitive detectors 479.

Thus, some but not necessarily all of the misbehavior indications output from the plausibility and consistency detectors 404 may be received by the misbehavior detector 473. In turn, the misbehavior detector 473 may use the received misbehavior indications to make a misbehavior determination 424 (e.g., whether a misbehavior condition exists in an event triggering misbehavior indications). The misbehavior determination 424 may be passed to and processed by the V2X processing equipment. Additionally, the misbehavior rate counter 474 may record or count the misbehavior determination 424, and on that basis determine a rate of misbehavior determinations being made by the aggregator system 471 per unit time (e.g., per minute, per hour, etc.).

As part of determining the rate of misbehavior determinations, the misbehavior rate counter 474 or separate comparing modules 475, 476, 477 may determine whether the rate of misbehavior determinations exceed a maximum threshold (determination block 475) or is less than a minimum threshold (determination block 476). Based on such comparisons, the aggregator system 471 may deactivate one or more sensitive detectors (478) if the rate of misbehavior determinations exceed a maximum threshold, or activate one or more sensitive detectors (479) if the rate of misbehavior determinations is less than a minimum threshold. In some embodiments, the plausibility and consistency detectors 404 that are activated or deactivated may be predetermined, such as in an order or ranking based upon the accuracy and/or precision of an associated sensor or source of information, and/or the importance or criticality to vehicle safety of the type of information addressed by the detector. In this manner, the aggregator system 471 may dynamically adjust the plausibility and consistency detectors 404 that are monitored for detecting misbehavior conditions responsive to the environment and vehicle sensors.

FIG. 4G illustrates another embodiment 460 for aggregating V2X misbehavior indications and determining whether a reportable or actionable misbehavior condition exists based on the aggregated misbehavior indications. With reference to FIGS. 1A-4G, in some embodiments, the misbehavior indications output by the plurality of misbehavior condition detectors 406-412 received and monitored by a misbehavior-in-majority V2X-information aggregator 462 that is configured to count or otherwise determine the number of event outputs per unit time (e.g., per five event outputs as illustrated) by each (or selected subsets) detector that is classified as or indicates an attack (or other misbehavior).

In some embodiments, the misbehavior-in-majority V2X-information aggregator 462 may determine (e.g., in determination block 468) whether a majority of events output by a given detector are classified as an attack (or other misbehavior) per unit time for any one detector 406-412 to a determination module or device 468 that determines whether, and output to the V2X processing system a determination that an event is a misbehavior condition 446 or a determining that the event is not a misbehavior condition 448 accordingly.

In some embodiments, the misbehavior-in-majority V2X-information aggregator 462 may determine (e.g., in determination block 468) whether a majority of events output by a misbehavior condition detectors 406-412 are classified as an attack (or other misbehavior) per unit time, and output to the V2X processing system a determination that an event is a misbehavior condition 446 or a determining that the event is not a misbehavior condition 448 accordingly. In some embodiments, a determination module or device 468 that determines whether a majority of events from a given detector are classified as an attack may be separate from and make the determination based on an output from the misbehavior-in-majority V2X-information aggregator 462.

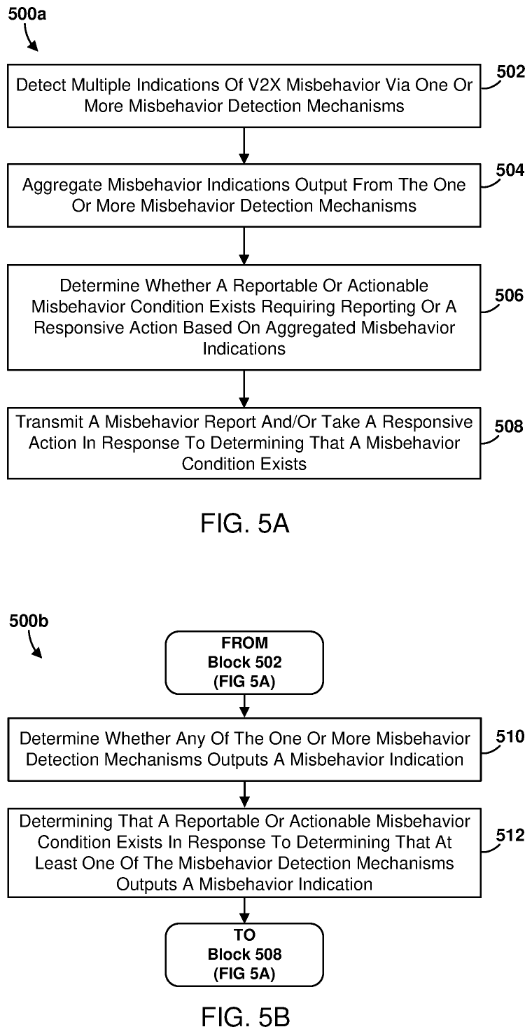

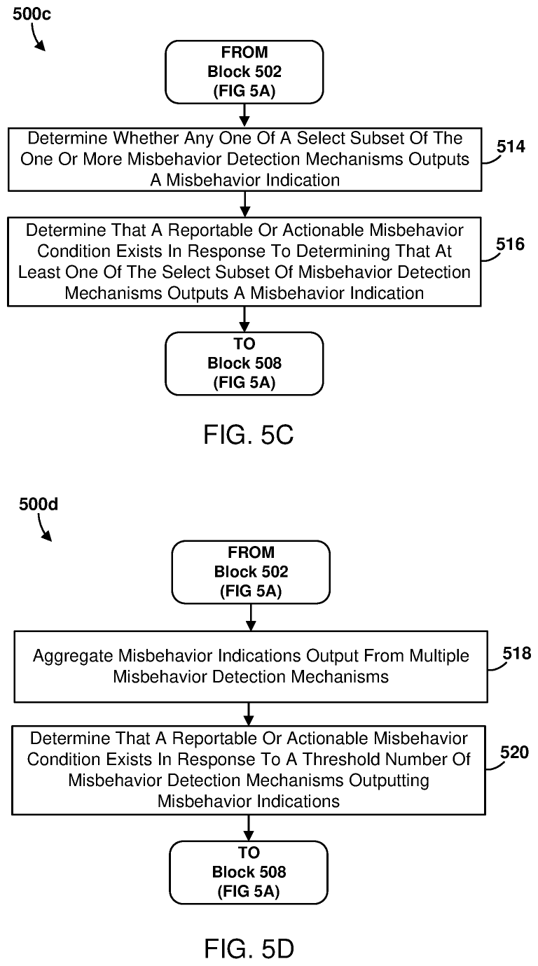

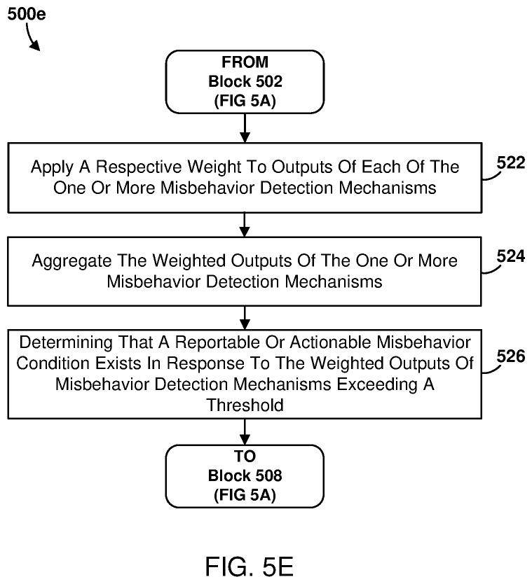

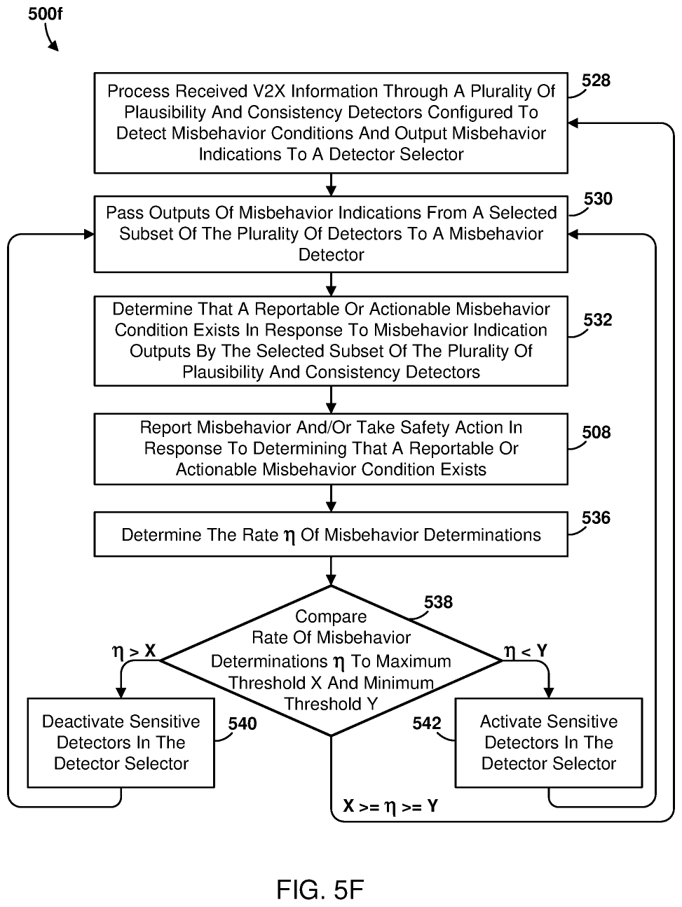

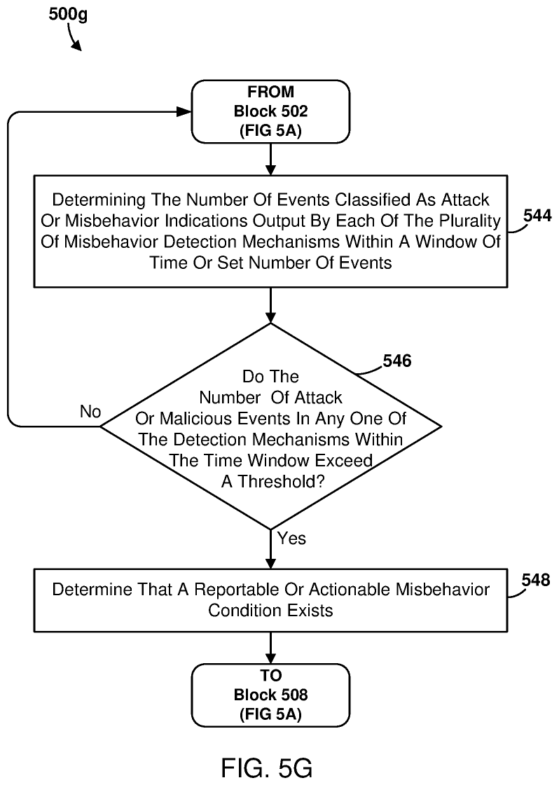

FIG. 5A is a process flow diagram of an example method 500a that may be performed by a processor of a V2X communications processing and management system (e.g., 104) of a vehicle for aggregating misbehavior indications received from a plurality of misbehavior detection mechanisms (i.e., misbehavior detection methods, modules and/or devices) and determining a reportable and/or actionable misbehavior condition based on aggregated misbehavior indications in accordance with various embodiments. FIGS. 5B-5H are process flow diagrams of example operations 500b-500h that may be performed as part as described for aggregating misbehavior indications received from a plurality of misbehavior detection mechanisms in accordance with some embodiments. With reference to FIGS. 1A-5G, the method 500a and the operations 500b-500h may be performed by a processor (e.g., 205, 300) of a vehicle V2X communications processing and management system or other vehicle processor (e.g., 104, 204, 205, 220, 300) that may be implemented in hardware elements, software elements, or a combination of hardware and software elements (referred to collectively as a “V2X processor”).

In block 502, the V2X processor may perform operations including detecting multiple indications of V2X misbehavior via one or more misbehavior detection mechanisms. The V2X processing system may be coupled to multiple vehicle sensors (e.g., cameras, radar, LIDAR, GPS receivers, etc.) and be configured to process information received in V2X messages (e.g., BSMs), and include software-implemented algorithms or modules, and/or devices configured to analyzed the information obtained from sensors and V2X messages to recognize inconsistent and/or implausible information indicative of a misbehavior condition. Such software-implemented algorithms or modules, and/or devices may be configured as misbehavior detection mechanism that output a misbehavior indication when inconsistencies or implausible conditions are detected that may be due to a V2X misbehavior condition (e.g., a deliberate attack or a sensor failure). Means for performing the operations of block 502 may include a processor (e.g., 205, 300) of a vehicle V2X communications processing and management system (e.g., 104, 204) executing the misbehavior detection mechanism modules 234.

In block 504, the V2X processor may perform operations including aggregating misbehavior indications output from the one or more misbehavior detection mechanisms. Aggregating misbehavior indications from multiple detectors (e.g., 406-412) may involve selecting or identifying misbehavior indications from one or selected misbehavior detection mechanisms for use in determining whether a misbehavior condition exits or is detected. In some embodiments, as part of the operations in block 504, multiple aggregators may receive misbehavior inputs from one or more of the detector mechanisms and apply aggregation methods that are appropriate for the type of detector mechanism coupled to or misbehavior indication processed by each aggregator. In some embodiments, each of multiple aggregators may be coupled to and configured to aggregate outputs from a corresponding one of multiple detector mechanisms.

Aggregating misbehavior indications and using the results of such aggregation to determine whether a misbehavior condition exits may avoid false detections and/or generation of redundant reports of misbehavior conditions. Based on different types of aggregation used in various embodiments described herein, the output of the misbehavior detection mechanisms may be selected, weighted, analyzed over time, or otherwise considered to support making a determination of whether a reportable and/or actional misbehavior condition exists. Means for performing the operations of block 504 may include a processor (e.g., 205, 300) of a vehicle V2X communications processing and management system (e.g., 104, 204) executing the misbehavior detection indication aggregator modules 236.

In block 506, the V2X processor may perform operations including determining whether a reportable or actionable misbehavior condition exists based on aggregated misbehavior indications. In some embodiments, the V2X processor may determine that a misbehavior condition exists in response to aggregations of any one of all or a selected number of the misbehavior detection mechanisms outputs a misbehavior indication. In some embodiments, the V2X processor may determine that a misbehavior condition exists in response to one or more aggregators determining that the number of misbehavior detection mechanisms outputting misbehavior indications satisfies or exceeds a threshold, such as a majority or a quorum of the multiple misbehavior detection mechanisms. In some embodiments, the V2X processor may determine that a misbehavior condition exists in response one or more aggregators indicating that one or more of the misbehavior indicators concluded that events are classified as an attack (or other misbehavior) within a unit time. Means for performing the operations of block 506 may include a processor (e.g., 205, 300) of a vehicle V2X communications processing and management system (e.g., 104, 204) executing the misbehavior condition determination module 238.

In block 508, the V2X processor may perform operations including transmitting a misbehavior report or taking a responsive action in response to determining that a misbehavior condition exists. For example, the V2X processor may generate a misbehavior report including information regarding the detected misbehavior, and initiate transmission of the generated misbehavior report. As another example, the V2X processor may take an action in response to a detected misbehavior condition, such as ignoring erroneous or malicious information, taking an action to guard against erroneous or malicious information, or initiate a driving response to ensure safe operation of the vehicle in view of erroneous or malicious information from a misbehavior condition. Means for performing the operations of block 508 may include a processor (e.g., 205, 300) of a vehicle V2X communications processing and management system (e.g., 104, 204) executing the misbehavior reporting module 240.

FIGS. 5B-5G are process flow diagrams of example operations 500b-500h that may be performed as part of aggregating misbehavior indications received from a plurality of misbehavior detection mechanisms and determining a reportable and/or actionable misbehavior condition based on aggregated misbehavior indications in accordance with some embodiments. The operations 500b-500h may be performed by a processor (e.g., 205) of a vehicle V2X communications processing and management system or other vehicle processor (e.g., 104, 204, 205, 220, 300) that may be implemented in hardware elements, software elements, or a combination of hardware and software elements (referred to collectively as a “V2X processor”).

FIG. 5B illustrates operations 500b that may be performed by a V2X processor for aggregating misbehavior indications in accordance with some embodiments. With reference to FIGS. 1A-5B, following the operations in block 502, the V2X processor may perform operations including determining whether any of the one or more misbehavior detection mechanisms outputs a misbehavior indication in block 510 as part of aggregating misbehavior indications output from the one or more misbehavior detection mechanisms. For example, as part of aggregating misbehavior indications output from the one or more misbehavior detection mechanisms the V2X processor may receive inputs from all misbehavior detection mechanisms, and determine that a misbehavior indication should be processed by the misbehavior detector in response to any misbehavior indication. In this regard, the aggregator may function as an OR gate, providing an output to a misbehavior detector in response to any positive indication of a misbehavior detection. Means for performing the operations of block 510 may include a processor (e.g., 205, 300) of a vehicle V2X communications processing and management system (e.g., 104, 204) executing the misbehavior detection indication aggregator modules 236.

In block 512, the V2X processor may perform operations including determining that a reportable or actionable misbehavior condition exists in response to determining that at least one of the misbehavior detection mechanisms outputs a misbehavior indication as part of determining whether a reportable or actionable misbehavior condition exists based on aggregated misbehavior indications. For example, a misbehavior detector may output to the rest of the V2X processing system a determination that a reportable or actionable misbehavior condition exists based upon the output from the aggregator in block 510. Means for performing the operations of block 512 may include a processor (e.g., 205, 300) of a vehicle V2X communications processing and management system (e.g., 104, 204) executing the misbehavior condition determination module 238.

After the operations in block 512, the V2X processor may perform the operations in block 508 as described.

FIG. 5C illustrates operations 500c that may be performed by a V2X processor for aggregating misbehavior indications in accordance with some embodiments. With reference to FIGS. 1A-5C, following the operations in block 502, the V2X processor may perform operations including determining whether any one of a select subset of the one or more misbehavior detection mechanisms outputs a misbehavior indication in block 514 as part of aggregating misbehavior indications output from the one or more misbehavior detection mechanisms. For example, as part of aggregating misbehavior indications output from the one or more misbehavior detection mechanisms the V2X processor may receive inputs from a select subset of the misbehavior detection mechanisms, and determine that a misbehavior indication should be processed by the misbehavior detector in response to any misbehavior indication from the select subset of misbehavior detection mechanisms, while other misbehavior indications from other misbehavior detection mechanisms are aggregated using other aggregation methods. In this regard, one or more aggregator may function as an OR gate for processing outputs from the select subset of the misbehavior detection mechanisms, providing an output to a misbehavior detector in response to any positive indication of a misbehavior detection from the select subset of misbehavior detection mechanisms. Such embodiments may be useful for aggregating a few misbehavior detection mechanisms that will detect misbehaviors with significant safety implications, such as misbehaviors related to determining or tracking the location of the vehicle and navigation. Means for performing the operations of block 514 may include a processor (e.g., 205, 300) of a vehicle V2X communications processing and management system (e.g., 104, 204) executing the misbehavior detection indication aggregator modules 236.

In block 516, the V2X processor may perform operations including determining that a reportable or actionable misbehavior condition exists in response to determining that at least one of the select subset of misbehavior detection mechanisms outputs a misbehavior indication as part of determining whether a reportable or actionable misbehavior condition exists based on aggregated misbehavior indications. In such embodiments, a misbehavior detector may output to the rest of the V2X processing system a determination that a reportable or actionable misbehavior condition exists based upon the output from the OR aggregator in block 514 or from other aggregators. Means for performing the operations of block 512 may include a processor (e.g., 205, 300) of a vehicle V2X communications processing and management system (e.g., 104, 204) executing the misbehavior condition determination module 238.

After the operations in block 516, the V2X processor may perform the operations in block 508 as described.

FIG. 5D illustrates operations 500d that may be performed by a V2X processor for aggregating misbehavior indications in accordance with some embodiments. With reference to FIGS. 1A-5D, following the operations in block 502, the V2X processor may perform operations including aggregating misbehavior indications output from multiple misbehavior detection mechanisms in block 518 as part of aggregating misbehavior indications output from the one or more misbehavior detection mechanisms. As part of this aggregation, the V2X processor may total the number of misbehavior detection mechanisms that are outputting positive misbehavior indications. Such a total may be calculated within the period of time, such as within one second, 10 seconds or minutes, as would be the case for a single event being detected by multiple misbehavior detection mechanisms. Means for performing the operations of block 5xx may include a processor (e.g., 205, 300) of a vehicle V2X communications processing and management system (e.g., 104, 204) executing the misbehavior detection indication aggregator modules 236.

In block 520, the V2X processor may perform operations including determining that a reportable or actionable misbehavior condition exists in response to a threshold number of the misbehavior detection mechanisms outputting misbehavior indications. In some embodiments, the threshold number may be any predefined number greater than one, thus requiring some substantiation or validation among multiple misbehavior detection mechanisms before the V2X processor determines that a reportable or actionable misbehavior condition exists. In some embodiments, the threshold number may be set at one more than half of the number of misbehavior detection mechanisms active in the V2X processing system, thus requiring a majority of misbehavior detection conditions to have detected an output behavior indications before the system determines that a reportable or actionable misbehavior condition exists. In some embodiments, the threshold number may be set at a number that is predefined as a quorum, such as more than half of the number of misbehavior detection mechanisms active in the V2X processing system, thus requiring a quorum of misbehavior detection conditions to have detected an output behavior indications before the system determines that a reportable or actionable misbehavior condition exists. In some embodiments, the threshold number may be set at a number substantially more than half of the number of misbehavior detection mechanisms active in the V2X processing system, thus requiring a super majority of misbehavior detection conditions to have detected an output behavior indications before the system determines that a reportable or actionable misbehavior condition exists. Such embodiments may guard against spurious determinations of reportable or actionable misbehavior conditions based on one or a few misbehavior detection mechanisms, which could be subject to error or their own misbehaviors. Means for performing the operations of block 520 may include a processor (e.g., 205, 300) of a vehicle V2X communications processing and management system (e.g., 104, 204) executing the misbehavior condition determination module 238.

After the operations in block 520, the V2X processor may perform the operations in block 508 as described.

FIG. 5E illustrates operations 500e that may be performed by a V2X processor for determining that a misbehavior condition exists based upon a weighted aggregation of misbehavior indications in accordance with some embodiments. With reference to FIGS. 1A-5E, following the operations in block 502, the V2X processor may perform operations including applying a respective weight to outputs of each of the one or more misbehavior detection mechanisms in block 522. The weight applied to each of the misbehavior detection mechanism outputs may depend upon a number of factors, including the criticality of misbehaviors detected by particular mechanisms, accuracy or sensitivity of particular detector mechanisms, and/or reliability of information that is used by the particular detection mechanisms. For example, the misbehavior indication outputs from misbehavior detection mechanisms that are configured to identify errors, inconsistencies or other misbehaviors related to safety-critical information (e.g., vehicle position or autonomous driving control) may be given greater weight than misbehavior indication outputs from misbehavior detection mechanisms configured to identify errors or inconsistencies in less critical information. Waiting misbehavior indications in this manner may enable the V2X processing system to more reliably recognize reportable or actionable misbehavior conditions from among many concurrent misbehavior indications that may be of lower importance or criticality to vehicle safety. Means for performing the operations of block 522 may include a processor (e.g., 205, 300) of a vehicle V2X communications processing and management system (e.g., 104, 204) executing the misbehavior detection indication aggregator modules 236.

In block 524, the V2X processor may perform operations including aggregating the weighted outputs of the one or more misbehavior detection mechanisms as part of aggregating misbehavior indications output from the one or more misbehavior detection mechanisms. For example, the V2X processor may add the weighted misbehavior indications to obtain a total weighted indication value. As another example, the V2X processor may determine an average weighted misbehavior indication by taking the average of all weighted misbehavior indications within the unit time. Other processing of weighted misbehavior indications may be used in block 524. Means for performing the operations of block 524 may include a processor (e.g., 205, 300) of a vehicle V2X communications processing and management system (e.g., 104, 204) executing the misbehavior detection indication aggregator modules 236.

In block 526, the V2X processor may perform operations including determining that a reportable or actionable misbehavior condition exists in response to the weighted outputs of misbehavior detection mechanisms exceeding a threshold. In some embodiments, the threshold may be any preset value that may be set by a V2X system provider, vehicle manufacturer, intelligent highway system management, Misbehavior Authority, or other authority. In some embodiments, the threshold may be set dynamically by the V2X system processor in response to and/or a rate of misbehavior determinations, or by an external authority (e.g., a Misbehavior Authority) such as via an over-the-air system update. Means for performing the operations of block 526 may include a processor (e.g., 205, 300) of a vehicle V2X communications processing and management system (e.g., 104, 204) executing the misbehavior condition determination module 238.

After the operations in block 526, the V2X processor may perform the operations in block 508 as described.

FIG. 5F illustrates operations 500f that may be performed by a V2X processor for adjusting the sensitivity of the V2X misbehavior detection capabilities dynamically in accordance with some embodiments. With reference to FIGS. 1A-5F, the V2X processor may perform operations including processing received V2X information, including sensor data, through a plurality of plausibility and consistency detectors configured to detect misbehavior conditions and output misbehavior indications to a detector selector (e.g., 472) in block 528. In some embodiments, such operations may be perform as part of detecting multiple indications of V2X misbehavior via one or more misbehavior detection mechanisms in block 502 as described. Means for performing the operations of block 528 may include a processor (e.g., 205, 300) of a vehicle V2X communications processing and management system (e.g., 104, 204) executing the V2X plausibility and consistency detector modules 242.

In block 530, the V2X processor may perform operations including passing outputs of misbehavior indications from a selected subset of the plurality of misbehavior detection mechanisms from the detector selector (e.g., 472) to a misbehavior detector (e.g., 473) as part of aggregating misbehavior indications output from the one or more misbehavior detection mechanisms. In such operations, the detector selector may function as a filter, accepting for processing the misbehavior indications output from particular ones of the plurality of plausibility and consistency detectors (e.g. 404), while not passing on misbehavior indications from non-selected detectors. In such embodiments, the particular plausibility and consistency detectors that are accepted for processing may be adjusted in response to various conditions, including in response to the rate at misbehavior determinations are being made as described. For example, upon initial activation, misbehavior indication outputs from all or a predetermined subset of the plausibility and consistency detectors may be passed to the misbehavior detector (e.g., 473), but over time filter settings of the detector selector may be adjusted so that the outputs from selected one or a few of the plausibility and consistency detectors will not be passed to the misbehavior detector. Means for performing the operations of block 530 may include a processor (e.g., 205, 300) of a vehicle V2X communications processing and management system (e.g., 104, 204) executing the detector selector module 244.

In block 532, the V2X processor may perform operations including determining by the misbehavior detector that a reportable or actionable misbehavior condition exists in response to misbehavior indication outputs by the selected subset of the plurality of plausibility and consistency detectors. In some embodiments, such operations may be performed as part of determining whether a reportable or actionable misbehavior condition exists based on aggregated misbehavior indications. Various methods may be used by the misbehavior detector 473 to identify reportable or actionable misbehavior conditions, including methods described herein, such as based on a threshold number (e.g., majority of a quorum) of reporting detectors, or a weighted aggregation of this behavior indications that were output by the detector selector (e.g., 472). Means for performing the operations of block 526 may include a processor (e.g., 205, 300) of a vehicle V2X communications processing and management system (e.g., 104, 204) executing the misbehavior detector module 246.

In block 508, the V2X processor may perform operations as described including reporting the misbehavior by transmitting a misbehavior report and/or taking a safety action or actions in response to determining that a reportable or actionable misbehavior condition exists. Means for performing the operations of block 508 may include a processor (e.g., 205, 300) of a vehicle V2X communications processing and management system (e.g., 104, 204) executing the misbehavior reporting module 240.

In block 536, the V2X processor may perform operations including determining the rate (i) of misbehavior determinations made in block 532. For example, in some embodiments, the V2X processor make the number of misbehavior determinations that are made within a given period of time, such as one minute, one hour, or one day, and divide by the length of the period of time to obtain a rate. As another example, in some embodiments, the V2X processor may count the number of misbehavior determinations within a given period of time and use that number as the current rate of misbehavior determinations. As a further example, in some embodiments, the V2X processor may average the time intervals between misbehavior determinations, and use that average interval to determine a rate of misbehavior determinations over the period of time that the averages were taken. Other means of determining a rate of misbehavior determinations may also be used by the V2X processor in block 536. Means for performing the operations of block 536 may include a processor (e.g., 205, 300) of a vehicle V2X communications processing and management system (e.g., 104, 204) executing the misbehavior rate determining modules 248.

In determination block 538, the V2X processor may perform operations including comparing the rate of misbehavior determinations (i) to a maximum threshold (X) and/or a minimum threshold (Y). In some embodiments, the V2X processor may determine whether the rate of misbehavior determinations exceeds the maximum threshold or is less than the minimum threshold. By performing this comparison, the V2X processor and determine whether the average rate at which misbehavior determinations are being made under the current circumstances is within a target range of determination rates. The maximum and/or minimum thresholds may be any preset value, and may be set by a V2X system provider, vehicle manufacturer, intelligent highway system management, Misbehavior Authority, or other authority. As a non-limiting example, the maximum threshold X may be 100 misbehavior determinations per second. Thus, when the V2X system is reporting or acting upon more misbehavior conditions per unit time than set by a suitable authority, the V2X processor can take actions in block 540 to reduce the sensitivity of the misbehavior detection system to maintain the misbehavior determination rate within the set range detection and reporting/action rates. As a non-limiting example, the minimum threshold Y may be one misbehavior determination in 10 seconds. Thus, when the V2X system is reporting or acting upon fewer misbehavior conditions per unit time than set by a suitable authority, the V2X processor can take actions in block 542 to increase the sensitivity of the misbehavior detection system to maintain the misbehavior determination rate within the set range detection and reporting/action rates. Means for performing the operations of block 538 may include a processor (e.g., 205, 300) of a vehicle V2X communications processing and management system (e.g., 104, 204) executing the misbehavior rate determining modules 248.

In block 540, in response to determining that the rate of misbehavior determinations (i) exceeds the maximum threshold (X), the V2X processor may perform operations including deactivating one or more sensitive plausibility and consistency detectors. For example, in block 540, the V2X processor may reconfigured the detector selector (e.g., 472) to begin filtering one or more plausibility and consistency detectors from which the detection indications were previously being passed to the misbehavior detector (e.g., 473). In some embodiments, the V2X processor may identify plausibility and consistency detectors that should be deactivated (i.e., whose misbehavior indications should be filtered) based upon a prioritization or ranking, which may depend upon the importance or criticality of the nature of misbehavior that each detector is configured to identify. In this manner, the V2X processor may selectively increase the filtering of misbehavior detections, and thus reduce the rate at which misbehavior conditions may be reported and/or acted upon. Means for performing the operations of block 540 may include a processor (e.g., 205, 300) of a vehicle V2X communications processing and management system (e.g., 104, 204) executing the V2X plausibility and consistency detector deactivating module 250.

In block 542, in response to determining that the rate of misbehavior determinations (i) is less than the minimum threshold Y, the V2X processor may perform operations including activating one or more sensitive plausibility and consistency detectors. For example, in block 540, the V2X processor may reconfigured the detector selector (e.g., 472) to stop filtering one or more plausibility and consistency detectors that were previously filtered so that subsequent misbehavior indications may be passed to the misbehavior detector (e.g., 473). In some embodiments, the V2X processor may identify plausibility and consistency detectors for activation (i.e., that should no longer be filtered) based upon a prioritization or ranking, which may depend upon the importance or criticality of the nature of misbehavior that each detector is configured to identify. In this manner, the V2X processor may selectively decrease the filtering of misbehavior detections, and thus increase the rate at which misbehavior conditions may be reported and/or acted upon. Means for performing the operations of block 540 may include a processor (e.g., 205, 300) of a vehicle V2X communications processing and management system (e.g., 104, 204) executing the V2X plausibility and consistency detector activating module 252.

In response to determining that the rate of misbehavior determinations (i) is between the maximum threshold X and minimum threshold Y, no change to the active plausibility and consistency detectors may be made, and the V2X processor may continue to perform the operations 500f by processing received V2X information through the plurality of plausibility and consistency detectors in block 528 as described.

FIG. 5G illustrates operations 500g that may be performed by a V2X processor for aggregating misbehavior indications and determining whether a misbehavior conditions exists in accordance with some embodiments. With reference to FIGS. 1A-5G, following the operations in block 502, the V2X processor may perform operations including determining a number of events classified as an attack or misbehavior indications output by each of a plurality of misbehavior detection mechanisms within a window of time or set number of events in block 544. For example, an aggregator may count events classified as an attacker other misbehavior within the string of outputs from each misbehavior detection mechanism, and determine from that count a fraction of the output indicating an attacker other misbehavior. This calculation may be accomplished for some or all of the misbehavior detection mechanisms within the V2X system. In some embodiments, this calculation may be performed continuously, such as maintaining a count of the number or fraction of a given number of outputs from misbehavior detection mechanisms that are classified as an attack or other misbehavior within a given number of outputs or a given window of time, and provide that running count or fraction as an output. Means for performing the operations of block 544 may include a processor (e.g., 205, 300) of a vehicle V2X communications processing and management system (e.g., 104, 204) executing the attack or misbehavior indication counting modules 254.

In determination block 546, the V2X processor may perform operations including determining whether the number of attack or malicious events indicated in any one of the misbehavior detection mechanisms exceeds a threshold within the window of time or set number of detector outputs or events. The threshold may be any number greater than one. In some embodiments, the threshold may be set to determine whether a majority of misbehavior indications from one or more of the misbehavior detection mechanisms indicates an attacker other misbehavior within the window of time or set number of detector outputs or events. Means for performing the operations of block 524 may include a processor (e.g., 205, 300) of a vehicle V2X communications processing and management system (e.g., 104, 204) executing the attack or misbehavior indication counting modules 254.

In response to determining that the number of attack or malicious events indicated in any one of the misbehavior detection mechanisms exceeds the threshold within the window of time or set number of events (i.e., determination block 546=“Yes”), the V2X processor may continue to detect multiple indications of V2X misbehavior via one or more misbehavior detection mechanisms in block 502 as described.

In response to determining that the number of attack or malicious events indicated in any one of the misbehavior detection mechanisms exceeds the threshold within the window of time or set number of events (i.e., determination block 546=“Yes”), the V2X processor may determine that a misbehavior condition exists block 548. As part of the operations in block 548, the V2X processor may output a misbehavior determination to other parts of the V2X system, such as to reporting and/or responsive functions for performing the operations in block 508 and/or determining the rate of misbehavior determinations in block 536 is described. Means for performing the operations of block 548 may include a processor (e.g., 205, 300) of a vehicle V2X communications processing and management system (e.g., 104, 204) executing the misbehavior condition determination module 238.

After the operations in block 548, the V2X processor may perform the operations in block 508 and/or block 548 as described.

Implementation examples are described in the following paragraphs. While some of the following implementation examples are described in terms of example methods, further example implementations may include: the example methods discussed in the following paragraphs implemented by a V2X communications processing and management system including a processor configured with processor-executable instructions to perform operations of the methods of the following implementation examples; the example methods discussed in the following paragraphs implemented by a V2X communications processing and management system including means for performing functions of the methods of the following implementation examples; and the example methods discussed in the following paragraphs may be implemented as a non-transitory processor-readable storage medium having stored thereon processor-executable instructions configured to cause a processor of a V2X communications processing and management system to perform the operations of the methods of the following implementation examples.

Example 1. A method performed by a processor of a V2X communication system of a vehicle, including: detecting multiple indications of V2X misbehavior via one or more misbehavior detection mechanisms; aggregating misbehavior indications output from the one or more misbehavior detection mechanisms; determining whether a reportable or actionable misbehavior condition exists based on aggregated misbehavior indications; and transmitting a misbehavior report or taking a responsive action in response to determining that a misbehavior condition exists.

Example 2. The method of example 1, in which: aggregating misbehavior indications output from the one or more misbehavior detection mechanisms includes determining whether any of the one or more misbehavior detection mechanisms outputs a misbehavior indication; and determining whether a reportable or actionable misbehavior condition exists based on aggregated misbehavior indications includes determining that a reportable or actionable misbehavior condition exists in response to determining that at least one of the misbehavior detection mechanisms outputs a misbehavior indication.

Example 3. The method of either of examples 1 or 2, in which: aggregating misbehavior indications output from the one or more misbehavior detection mechanisms includes determining whether any one of a select subset of the one or more misbehavior detection mechanisms outputs a misbehavior indication; and determining whether a reportable or actionable misbehavior condition exists based on aggregated misbehavior indications includes determining that a reportable or actionable misbehavior condition exists in response to determining that at least one of the select subset of misbehavior detection mechanisms outputs a misbehavior indication.

Example 4. The example of any of example 1-3, in which: aggregating misbehavior indications output from the one or more misbehavior detection mechanisms includes aggregating misbehavior indications output from multiple misbehavior detection mechanisms; and determining whether a reportable or actionable misbehavior condition exists based on aggregated misbehavior indications includes determining that a reportable or actionable misbehavior condition exists in response to a threshold number of the misbehavior detection mechanisms outputting misbehavior indications.

Example 5. The method of example 4, in which determining that a reportable or actionable misbehavior condition exists in response to a threshold number of the misbehavior detection mechanisms outputting misbehavior indications includes determining that a reportable or actionable misbehavior condition exists in response to a majority of the misbehavior detection mechanisms outputting misbehavior indications.

Example 6. The method of any of examples 1-5, in which: aggregating misbehavior indications output from the one or more misbehavior detection mechanisms includes: applying a respective weight to outputs of each of the one or more misbehavior detection mechanisms; and aggregating the weighted outputs of the one or more misbehavior detection mechanisms; and determining whether a reportable or actionable misbehavior condition exists based on aggregated misbehavior indications includes determining that a reportable or actionable misbehavior condition exists in response to the weighted outputs of misbehavior detection mechanisms exceeding a threshold.

Example 7. The method of any of examples 1-6, in which: detecting multiple indications of V2X misbehavior via one or more misbehavior detection mechanism includes processing received V2X information through a plurality of plausibility and consistency detectors configured to detect misbehavior conditions and output misbehavior indications to a detector selector; aggregating misbehavior indications output from the one or more misbehavior detection mechanisms includes passing outputs of misbehavior indications from a selected subset of the plurality of plausibility and consistency detectors from the detector selector to a misbehavior detector; determining whether a reportable or actionable misbehavior condition exists based on aggregated misbehavior indications includes determining by the misbehavior detector that a reportable or actionable misbehavior condition exists in response to misbehavior indication outputs by the selected subset of the plurality of plausibility and consistency detectors; and the example further includes: determining a rate of misbehavior determinations; determining whether the rate of misbehavior determinations exceeds a maximum threshold or is less than a minimum threshold; deactivating one or more sensitive plausibility and consistency detectors in response to determining that the rate of misbehavior determinations exceeds the maximum threshold; and activating one or more sensitive plausibility and consistency detectors in response to determining that the rate of misbehavior determinations is less than the minimum threshold.

Example 8. The method of any of examples 1-7, in which: aggregating misbehavior indications output from the one or more misbehavior detection mechanisms includes determining a number of events classified as an attack or misbehavior indications output by each of a plurality of misbehavior detection mechanisms within a window of time or set number of events; and determining whether a reportable or actionable misbehavior condition exists based on aggregated misbehavior indications includes determining that a reportable or actionable misbehavior condition exists in response to determining that the number of events classified as an attack or misbehavior indications output by any one of the plurality of misbehavior detection mechanisms within the window of time or set number of events exceeds a threshold.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of a vehicle-to-everything (V2X) communication system of a vehicle, comprising:
detecting multiple indications of V2X misbehavior via one or more misbehavior detection mechanisms;
aggregating misbehavior indications output from the one or more misbehavior detection mechanisms;
determining whether a reportable or actionable misbehavior condition exists based on aggregated misbehavior indications; and
transmitting a misbehavior report or taking a responsive action in response to determining that a misbehavior condition exists.

2. The method of claim 1, wherein:
aggregating misbehavior indications output from the one or more misbehavior detection mechanisms comprises determining whether any of the one or more misbehavior detection mechanisms outputs a misbehavior indication; and
determining whether a reportable or actionable misbehavior condition exists based on aggregated misbehavior indications comprises determining that a reportable or actionable misbehavior condition exists in response to determining that at least one of the misbehavior detection mechanisms outputs a misbehavior indication.

3. The method of claim 1, wherein:
aggregating misbehavior indications output from the one or more misbehavior detection mechanisms comprises determining whether any one of a select subset of the one or more misbehavior detection mechanisms outputs a misbehavior indication; and
determining whether a reportable or actionable misbehavior condition exists based on aggregated misbehavior indications comprises determining that a reportable or actionable misbehavior condition exists in response to determining that at least one of the select subset of misbehavior detection mechanisms outputs a misbehavior indication.

4. The method of claim 1, wherein:
aggregating misbehavior indications output from the one or more misbehavior detection mechanisms comprises aggregating misbehavior indications output from multiple misbehavior detection mechanisms; and
determining whether a reportable or actionable misbehavior condition exists based on aggregated misbehavior indications comprises determining that a reportable or actionable misbehavior condition exists in response to a threshold number of the misbehavior detection mechanisms outputting misbehavior indications.

5. The method of claim 4, wherein determining that a reportable or actionable misbehavior condition exists in response to a threshold number of the misbehavior detection mechanisms outputting misbehavior indications comprises determining that a reportable or actionable misbehavior condition exists in response to a majority of the misbehavior detection mechanisms outputting misbehavior indications.

6. The method of claim 1, wherein:
aggregating misbehavior indications output from the one or more misbehavior detection mechanisms comprises:
applying a respective weight to outputs of each of the one or more misbehavior detection mechanisms; and
aggregating the weighted outputs of the one or more misbehavior detection mechanisms; and
determining whether a reportable or actionable misbehavior condition exists based on aggregated misbehavior indications comprises determining that a reportable or actionable misbehavior condition exists in response to the weighted outputs of misbehavior detection mechanisms exceeding a threshold.

7. The method of claim 1, wherein:
detecting multiple indications of V2X misbehavior via one or more misbehavior detection mechanism comprises processing received V2X information through a plurality of plausibility and consistency detectors configured to detect misbehavior conditions and output misbehavior indications to a detector selector;
aggregating misbehavior indications output from the one or more misbehavior detection mechanisms comprises passing outputs of misbehavior indications from a selected subset of the plurality of plausibility and consistency detectors from the detector selector to a misbehavior detector;
determining whether a reportable or actionable misbehavior condition exists based on aggregated misbehavior indications comprises determining by the misbehavior detector that a reportable or actionable misbehavior condition exists in response to misbehavior indication outputs by the selected subset of the plurality of plausibility and consistency detectors; and
the method further comprises:
determining a rate of misbehavior determinations;
determining whether the rate of misbehavior determinations exceeds a maximum threshold or is less than a minimum threshold;
deactivating one or more sensitive plausibility and consistency detectors in response to determining that the rate of misbehavior determinations exceeds the maximum threshold; and
activating one or more sensitive plausibility and consistency detectors in response to determining that the rate of misbehavior determinations is less than the minimum threshold.

8. The method of claim 1, wherein:
aggregating misbehavior indications output from the one or more misbehavior detection mechanisms comprises determining a number of events classified as an attack or misbehavior indications output by each of a plurality of misbehavior detection mechanisms within a window of time or set number of events; and
determining whether a reportable or actionable misbehavior condition exists based on aggregated misbehavior indications comprises determining that a reportable or actionable misbehavior condition exists in response to determining that the number of events classified as an attack or misbehavior indications output by any one of the plurality of misbehavior detection mechanisms within the window of time or set number of events exceeds a threshold.

9. A vehicle-to-everything (V2X) communication system, comprising:
a processor configured with processor-executable instructions to:
detecting multiple indications of V2X misbehavior via one or more misbehavior detection mechanisms;
aggregating misbehavior indications output from the one or more misbehavior detection mechanisms;
determining whether a reportable or actionable misbehavior condition exists based on aggregated misbehavior indications; and
transmitting a misbehavior report or taking a responsive action in response to determining that a misbehavior condition exists.

10. The V2X communication system of claim 9, wherein the processor is further configured with processor-executable instructions to:
aggregate misbehavior indications output from the one or more misbehavior detection mechanisms by determining whether any of the one or more misbehavior detection mechanisms outputs a misbehavior indication; and
determine whether a reportable or actionable misbehavior condition exists based on aggregated misbehavior indications by determining that a reportable or actionable misbehavior condition exists in response to determining that at least one of the misbehavior detection mechanisms outputs a misbehavior indication.

11. The V2X communication system of claim 9, wherein the processor is further configured with processor-executable instructions to:
aggregate misbehavior indications output from the one or more misbehavior detection mechanisms by determining whether any one of a select subset of the one or more misbehavior detection mechanisms outputs a misbehavior indication; and
determine whether a reportable or actionable misbehavior condition exists based on aggregated misbehavior indications by determining that a reportable or actionable misbehavior condition exists in response to determining that at least one of the select subset of misbehavior detection mechanisms outputs a misbehavior indication.

12. The V2X communication system of claim 9, wherein the processor is further configured with processor-executable instructions to:
aggregate misbehavior indications output from the one or more misbehavior detection mechanisms by aggregating misbehavior indications output from multiple misbehavior detection mechanisms; and
determine whether a reportable or actionable misbehavior condition exists based on aggregated misbehavior indications by determining that a reportable or actionable misbehavior condition exists in response to a threshold number of the misbehavior detection mechanisms outputting misbehavior indications.

13. The V2X communication system of claim 12, wherein the processor is further configured with processor-executable instructions to determine that a reportable or actionable misbehavior condition exists in response to a majority of the misbehavior detection mechanisms outputting misbehavior indications.

14. The V2X communication system of claim 9, wherein the processor is further configured with processor-executable instructions to:
aggregate misbehavior indications output from the one or more misbehavior detection mechanisms by:
applying a respective weight to outputs of each of the one or more misbehavior detection mechanisms; and
aggregating the weighted outputs of the one or more misbehavior detection mechanisms; and
determine whether a reportable or actionable misbehavior condition exists based on aggregated misbehavior indications by determining that a reportable or actionable misbehavior condition exists in response to the weighted outputs of misbehavior detection mechanisms exceeding a threshold.

15. The V2X communication system of claim 9, wherein the processor is further configured with processor-executable instructions to:
detect multiple indications of V2X misbehavior via one or more misbehavior detection mechanism by processing received V2X information through a plurality of plausibility and consistency detectors configured to detect misbehavior conditions and output misbehavior indications to a detector selector;
aggregate misbehavior indications output from the one or more misbehavior detection mechanisms by passing outputs of misbehavior indications from a selected subset of the plurality of plausibility and consistency detectors from the detector selector to a misbehavior detector;
determine whether a reportable or actionable misbehavior condition exists based on aggregated misbehavior indications by determining by the misbehavior detector that a reportable or actionable misbehavior condition exists in response to misbehavior indication outputs by the selected subset of the plurality of plausibility and consistency detectors;
determine a rate of misbehavior determinations;
determine whether the rate of misbehavior determinations exceeds a maximum threshold or is less than a minimum threshold;
deactivate one or more sensitive plausibility and consistency detectors in response to determining that the rate of misbehavior determinations exceeds the maximum threshold; and
activate one or more sensitive plausibility and consistency detectors in response to determining that the rate of misbehavior determinations is less than the minimum threshold.

16. The V2X communication system of claim 9, wherein the processor is further configured with processor-executable instructions to:
aggregate misbehavior indications output from the one or more misbehavior detection mechanisms by determining a number of events classified as an attack or misbehavior indications output by each of a plurality of misbehavior detection mechanisms within a window of time or set number of events; and
determine whether a reportable or actionable misbehavior condition exists based on aggregated misbehavior indications by determining that a reportable or actionable misbehavior condition exists in response to determining that the number of events classified as an attack or misbehavior indications output by any one of the plurality of misbehavior detection mechanisms within the window of time or set number of events exceeds a threshold.

17. A vehicle-to-everything (V2X) communication system of a vehicle, comprising:
means for detecting multiple indications of V2X misbehavior via one or more misbehavior detection mechanisms;
means for aggregating misbehavior indications output from the one or more misbehavior detection mechanisms;
means for determining whether a reportable or actionable misbehavior condition exists based on aggregated misbehavior indications; and
means for transmitting a misbehavior report or taking a responsive action in response to determining that a misbehavior condition exists.

18. The V2X communication system of claim 17, wherein:
means for aggregating misbehavior indications output from the one or more misbehavior detection mechanisms comprises means for determining whether any of the one or more misbehavior detection mechanisms outputs a misbehavior indication; and
means for determining whether a reportable or actionable misbehavior condition exists based on aggregated misbehavior indications comprises means for determining that a reportable or actionable misbehavior condition exists in response to determining that at least one of the misbehavior detection mechanisms outputs a misbehavior indication.

19. The V2X communication system of claim 17, wherein:
means for aggregating misbehavior indications output from the one or more misbehavior detection mechanisms comprises means for determining whether any one of a select subset of the one or more misbehavior detection mechanisms outputs a misbehavior indication; and
means for determining whether a reportable or actionable misbehavior condition exists based on aggregated misbehavior indications comprises means for determining that a reportable or actionable misbehavior condition exists in response to determining that at least one of the select subset of misbehavior detection mechanisms outputs a misbehavior indication.

20. The V2X communication system of claim 17, wherein:
means for aggregating misbehavior indications output from the one or more misbehavior detection mechanisms comprises means for aggregating misbehavior indications output from multiple misbehavior detection mechanisms; and
means for determining whether a reportable or actionable misbehavior condition exists based on aggregated misbehavior indications comprises means for determining that a reportable or actionable misbehavior condition exists in response to a threshold number of the misbehavior detection mechanisms outputting misbehavior indications.

21. The V2X communication system of claim 20, wherein means for determining that a reportable or actionable misbehavior condition exists in response to a threshold number of the misbehavior detection mechanisms outputting misbehavior indications comprises means for determining that a reportable or actionable misbehavior condition exists in response to a majority of the misbehavior detection mechanisms outputting misbehavior indications.

22. The V2X communication system of claim 17, wherein:
means for aggregating misbehavior indications output from the one or more misbehavior detection mechanisms comprises:
means for applying a respective weight to outputs of each of the one or more misbehavior detection mechanisms; and
means for aggregating the weighted outputs of the one or more misbehavior detection mechanisms; and
means for determining whether a reportable or actionable misbehavior condition exists based on aggregated misbehavior indications comprises means for determining that a reportable or actionable misbehavior condition exists in response to the weighted outputs of misbehavior detection mechanisms exceeding a threshold.

23. The V2X communication system of claim 17, wherein:
means for detecting multiple indications of V2X misbehavior via one or more misbehavior detection mechanism comprises means for processing received V2X information through a plurality of plausibility and consistency detectors configured to detect misbehavior conditions and output misbehavior indications to a detector selector;
means for aggregating misbehavior indications output from the one or more misbehavior detection mechanisms comprises means for passing outputs of misbehavior indications from a selected subset of the plurality of plausibility and consistency detectors from the detector selector to a misbehavior detector;
means for determining whether a reportable or actionable misbehavior condition exists based on aggregated misbehavior indications comprises means for determining by the misbehavior detector that a reportable or actionable misbehavior condition exists in response to misbehavior indication outputs by the selected subset of the plurality of plausibility and consistency detectors; and
the V2X communication system further comprises:
means for determining a rate of misbehavior determinations;
means for determining whether the rate of misbehavior determinations exceeds a maximum threshold or is less than a minimum threshold;
means for means for deactivating one or more sensitive plausibility and consistency detectors in response to determining that the rate of misbehavior determinations exceeds the maximum threshold; and
means for activating one or more sensitive plausibility and consistency detectors in response to determining that the rate of misbehavior determinations is less than the minimum threshold.

24. The V2X communication system of claim 17, wherein:
means for aggregating misbehavior indications output from the one or more misbehavior detection mechanisms comprises means for means for determining a number of events classified as an attack or misbehavior indications output by each of a plurality of misbehavior detection mechanisms within a window of time or set number of events; and
means for determining whether a reportable or actionable misbehavior condition exists based on aggregated misbehavior indications comprises means for means for determining that a reportable or actionable misbehavior condition exists in response to determining that the number of events classified as an attack or misbehavior indications output by any one of the plurality of misbehavior detection mechanisms within the window of time or set number of events exceeds a threshold.

25. A non-transitory processor-readable medium having stored thereon processor-executable instructions configured to cause a processor of a vehicle-to-everything (V2X) communication system to perform operations comprising:
detecting multiple indications of V2X misbehavior via one or more misbehavior detection mechanisms;
aggregating misbehavior indications output from the one or more misbehavior detection mechanisms;
determining whether a reportable or actionable misbehavior condition exists based on aggregated misbehavior indications; and
transmitting a misbehavior report or taking a responsive action in response to determining that a misbehavior condition exists.

26. The non-transitory processor-readable medium of claim 25, wherein the stored processor-executable instructions are further configured to cause the processor of the V2X communication system to perform operations such that:
aggregating misbehavior indications output from the one or more misbehavior detection mechanisms comprises determining whether any or any one of a select subset of the one or more misbehavior detection mechanisms outputs a misbehavior indication; and
determining whether a reportable or actionable misbehavior condition exists based on aggregated misbehavior indications comprises determining that a reportable or actionable misbehavior condition exists in response to determining that at least one of misbehavior detection mechanisms or at least one of the select subset of misbehavior detection mechanisms outputs a misbehavior indication.

27. The non-transitory processor-readable medium of claim 25, wherein the stored processor-executable instructions are further configured to cause the processor of the V2X communication system to perform operations such that:
aggregating misbehavior indications output from the one or more misbehavior detection mechanisms comprises aggregating misbehavior indications output from multiple misbehavior detection mechanisms; and
determining whether a reportable or actionable misbehavior condition exists based on aggregated misbehavior indications comprises determining that a reportable or actionable misbehavior condition exists in response to a threshold number of the misbehavior detection mechanisms outputting misbehavior indications.

28. The non-transitory processor-readable medium of claim 25, wherein the stored processor-executable instructions are further configured to cause the processor of the V2X communication system to perform operations such that:
aggregating misbehavior indications output from the one or more misbehavior detection mechanisms comprises:
applying a respective weight to outputs of each of the one or more misbehavior detection mechanisms; and
aggregating the weighted outputs of the one or more misbehavior detection mechanisms; and
determining whether a reportable or actionable misbehavior condition exists based on aggregated misbehavior indications comprises determining that a reportable or actionable misbehavior condition exists in response to the weighted outputs of misbehavior detection mechanisms exceeding a threshold.

29. The non-transitory processor-readable medium of claim 25, wherein the stored processor-executable instructions are further configured to cause the processor of the V2X communication system to perform operations such that:
detecting multiple indications of V2X misbehavior via one or more misbehavior detection mechanism comprises processing received V2X information through a plurality of plausibility and consistency detectors configured to detect misbehavior conditions and output misbehavior indications to a detector selector;
aggregating misbehavior indications output from the one or more misbehavior detection mechanisms comprises passing outputs of misbehavior indications from a selected subset of the plurality of plausibility and consistency detectors from the detector selector to a misbehavior detector; and
determining whether a reportable or actionable misbehavior condition exists based on aggregated misbehavior indications comprises determining by the misbehavior detector that a reportable or actionable misbehavior condition exists in response to misbehavior indication outputs by the selected subset of the plurality of plausibility and consistency detectors, and
wherein the stored processor-executable instructions are further configured to cause the processor of the V2X communication system to perform operations further comprising:
determining a rate of misbehavior determinations;
determining whether the rate of misbehavior determinations exceeds a maximum threshold or is less than a minimum threshold;
deactivating one or more sensitive plausibility and consistency detectors in response to determining that the rate of misbehavior determinations exceeds the maximum threshold; and
activating one or more sensitive plausibility and consistency detectors in response to determining that the rate of misbehavior determinations is less than the minimum threshold.

30. The non-transitory processor-readable medium of claim 25, wherein the stored processor-executable instructions are further configured to cause the processor of the V2X communication system to perform operations such that:
aggregating misbehavior indications output from the one or more misbehavior detection mechanisms comprises determining a number of events classified as an attack or misbehavior indications output by each of a plurality of misbehavior detection mechanisms within a window of time or set number of events; and
determining whether a reportable or actionable misbehavior condition exists based on aggregated misbehavior indications comprises determining that a reportable or actionable misbehavior condition exists in response to determining that the number of events classified as an attack or misbehavior indications output by any one of the plurality of misbehavior detection mechanisms within the window of time or set number of events exceeds a threshold.
